(19) United States
(12) Patent Application Publication
(10) Pub. No.: US 2002/0116210 A1
(43) Pub. Date: Aug. 22, 2002

(54) Computerized method for online quoting and pricing of tasks

(75) Inventors: Martin J. Medina, Hanover, PA (US); John J. Deinlein, Odenton, MD (US); Joseph A. Williams, Crofton, MD (US); Gary L. Gillette, Montgomery Village, MD (US); Hedy L. Dachel, Silverdale, WA (US); Christopher Wolf, Eldersburg, MD (US)

Correspondence Address: Intellectual Property, Honeywell International Inc., Law Department, AB/2, 101 Columbia Road, Morristown, NJ, 07962, US

(73) Assignee: Honeywell International Inc., Morristown, NJ (US)

(21) Appl. No.: 10/027,988

(22) Filed: Dec. 20, 2001

Related U.S. Application Data
(60) Provisional application No. 60/269,920, filed on Feb. 20, 2001.

(51) Int. Cl. G06F 17/60

(52) U.S. Cl. 705/1

(57) ABSTRACT

Computerized system and method for coordinating business information flow to permit a provider of goods or services to prepare a project proposal including a price quote for a project requested by a customer.

### RELATED APPLICATION

This Application claims priority from U.S. Provisional Application Serial Number 60/269,920, filed Feb. 20, 2001, for “METHOD AND SYSTEM FOR ON-LINE QUOTING AND PRICING OF TASKS”, the teachings of which are incorporated herein by reference in the entirety to the extent that they do not conflict with the Application. The related Provisional Application has the same inventorships, and a common assignee as the present Application.

### FIELD OF THE INVENTION

The present invention relates generally to a computerized method for coordinating business information flow, and more particularly a computerized method for implementing online quoting and pricing of projects or tasks between a business and its customers.

### BACKGROUND OF THE INVENTION

In most businesses, quoting a fair price for services and/or goods to a customer in an efficient and timely manner is crucial for maintaining viability. A company preparing a quote, must first identify the specific needs and requirements of the customer for a proposed project. The information gathered is subsequently prepared for submission to the company in the form of a statement of work or quote order. Once submitted, the company processes the information contained therein to identify and select suitable resources such as labor, material, travel, and the like. The resources are selected according to availability and ability to meet the needs of the project. The prices for the selected resources and the costs for the project are ascertained through contact with the individual resource providers, and tallied to generate a quote. The statement of work and the quote are then reviewed and analyzed for feasibility (i.e., contractual and financial projections) prior to approval and proposal to the customer.

Traditionally, this process requires significant shifting of paperwork and correspondence between various departments and organizations within the company to carry out the above-described tasks. Conventional systems and processes using such paper-based communications (i.e., postal mail, interdepartmental mail, and facsimile transmission) do not facilitate timely generation and processing of statements of work and corresponding resource selection and pricing. As a result, implementation of traditional processes usually requires considerable time and labor, and is typically complicated and prone to errors especially when quoting task orders, indefinite delivery, indefinite quantity (IDIQ) and blanket purchase agreements. Errors produced by such processes can result in loss profits and poor allocation of resources by the company.

Conventional systems and processes also lack appropriate check/balance mechanisms or fail-safe features to minimize delayed or missing statements of work. Furthermore, there are usually significant process variations between personnel, departments, resource providers, and organizations of the company. Such variations further contribute to differences in pricing schemes for similar tasks leading to further inefficiencies and uncertainties. Accordingly, these problems can seriously encumber a company's ability to attract and maintain customers and to effectively meet the needs of the customer in a timely and efficient manner.

The foregoing demonstrates that there is a need for an invention that avoids or minimizes the problems described above. There is a further need for an invention that greatly reduces the time and labor required to formulate price quotes by businesses for their customers, which improves responsiveness to the needs of the customer, and which accomplishes these goals in a cost efficient and effective manner.

### SUMMARY OF THE INVENTION

The present invention is directed to a method and system for coordinating business information flow during preparation of a project proposal for a customer and which satisfy the needs and avoids the deficiencies of the prior art. The method and system provide an interactive setting for companies of all sizes and types of organizational structures to meet their needs to efficiently and quickly process statements of work and generate price quotes for customers while improving overall cost efficiency and profitability. The method and system are easy to implement and use, and serves to effectively standardize, streamline and centralize the identification and pricing of available resources for the company, while improving responsiveness to the customer's needs.

The method and system of the present invention further include suitable time allocation mechanisms, check and balance means, and fail-safe features to minimize single points of failure and improve accountability through generation of appropriate flags and automatic responses. The invention further affords access to an assortment of databases to enable personnel to locate information and find solutions to accomplish the goals of the price quoting process.

In accordance with one aspect of the present invention, there is provided a method implemented via a computerized system for coordinating business information flow to permit a provider of goods or services to prepare a project proposal including a price quote for a project requested by a customer. The system includes a central server programmed to execute the method. A communications channel is established between the central server and a computer, and a statement of work comprising project data corresponding to project details, terms, requirements, and comments using a project information template is created and transmitted over the communications channel to the central server from the client computer to initiate preparation of the project proposal.

Further, in accordance with an aspect of our invention, a resource database is provided which stores resource data relating to available resources and which can be searched using a search template for identifying and selecting available resources suitable for completing the project defined by the statement of work. Data relating to selected resources and project data are incorporated into the statement of work where it is then processed to generate the price quote in preparation of the project proposal, and an evaluation summary report of the project proposal, detailing the project data and selected resource data of selected available resources, is prepared for review and approval by the provider of goods or services.

In the present invention, the company maintains and administers the operation of the server for access by authorized company personnel and customers through client computers or terminals connected to the server for carrying out the present inventive methods as will be further described hereinafter.

### BRIEF DESCRIPTION OF THE DRAWINGS

Various embodiments of the invention are described in detail below with reference to the drawings, in which like items are identified by the same reference designation, wherein:

FIG. 1 is a schematic diagram of a client-server system for one embodiment of the present invention;

FIG. 2 is a flow chart showing the general steps for coordinating business information flow to prepare a project proposal as implemented by the system of FIG. 1 for one embodiment of the present invention;

FIGS. 3 to 5 illustrate a flowchart showing the method for coordinating business information flow to prepare a project proposal in accordance with the principles of the present invention; and

FIGS. 6 to 50 each illustrate a view screen in accordance with the principles of the present invention.

### DESCRIPTION OF THE INVENTION AND PREFERRED EMBODIMENTS

The present invention provides a method and a system for coordinating business information flow to permit a provider of goods or services to prepare a project proposal including a price quote for a project requested by a customer. The method and system of the present invention combine business procedures and rules with software to automate the preparation of a quote to a customer for goods or services. The business rules incorporated into the software serve to govern appropriate delegation of authority, cycle time tolerance, task responsibilities, and review of financial acceptability and business feasibility.

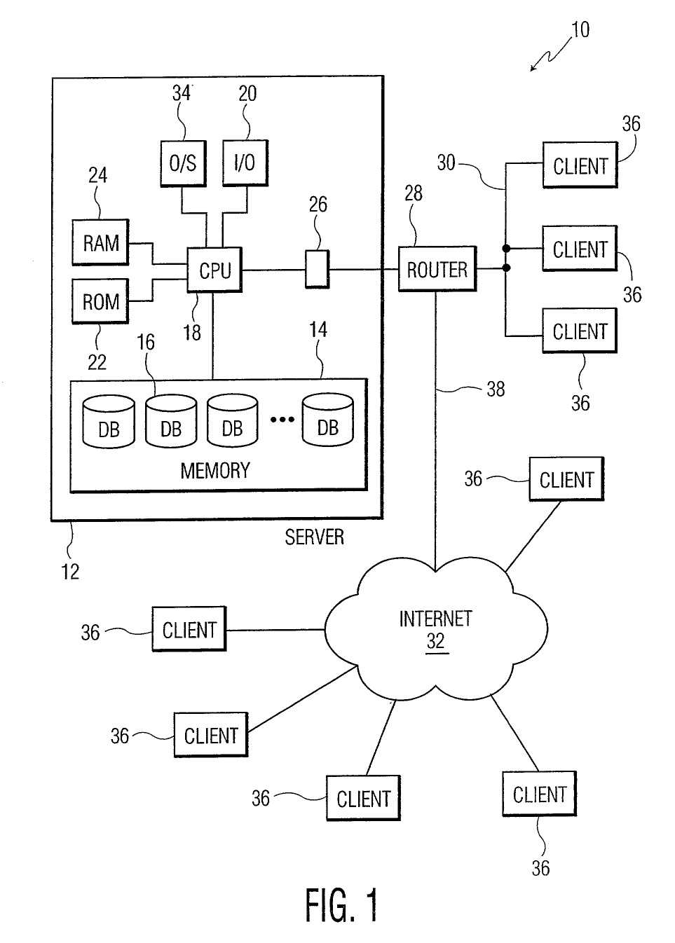

With reference to FIG. 1, there is depicted a system 10 for communicating pricing information and processing of a statement of work submitted to a company by a customer, according to one illustrative embodiment of the invention. The system 10 includes a server 12 having a memory 14 including one or more databases 16 defined in the memory 14. The server 12 can be a mainframe computer, a UNIX-based machine, a personal computer, or any other suitable computer. The memory 14 is preferably non-volatile (e.g., CD-ROM, ZIP drive, hard disk, tape drive, etc.).

The server 12 includes a central processing unit (CPU) 18, an input/output component 20 for supporting peripheral I/O devices (not shown) such as keyboard, mouse, display, printer and the like, random access memory (RAM) 24, read-only memory (ROM) 22, serial and parallel ports (not shown), and a network interface or communication device 26. The communication device 26 connects the server 12 to computer networks including wide area networks (WAN) such as the Internet and local area networks such as a private intranet or extranet.

In a preferred embodiment, the server 12 is a World Wide Web server connected through a router 28 to an intranet 30 (e.g., company's computer network) and a global communications network 32 (i.e., the Internet). Preferably, the server 12 includes an operating system 34 that is capable of networking, providing a secure access environment, and accommodating multiple remote users and multi-tasking such as UNIX, Windows NT, Windows XP, LINUX, and the like. The system 10 further includes one or more client computers 36 which are adapted to communicate with the server 12 through interconnections between and among the various components in the server as known in the art.

It is understood that the CPU, memory, networking capabilities, storage, and software can be modified as appropriate to meet specific requirements. The selection of a suitable server requires consideration of CPU speed and disk subsystem performance and network bandwidth. The size of the databases and their projected growth must be analyzed as part of the known design considerations.

The client computers 36 can be connected to the server 12 through communication links such as the intranet 30 and the Internet via communication channel 38. The communication links between the server 12 and the client computers 36 can include a range of connections, including telephone links, hardwired connections, satellite links or other wireless connections, broadband channels, cable links, any combinations of the preceding, or any suitable type of connection for facilitating data and communications traffic. Multiple client computers 36 can communicate simultaneously with the server 12, and each connection can be made through a different type of link (e.g., one connection can be made by cable while another can be made by the Internet). As discussed above, the server 12 connects to the communication links through the communication device 26.

After a link is established between the server 12 and a client computer 26, communication can take place via a variety of communication protocols, including file transfer protocol (FTP), hypertext transfer protocol (HTTP), electronic mail (email), transfer control protocol/Internet protocol (TCP/IP), XMODEM, YMODEM, KERMIT, ISDN, frame relay, V.32, ethernet, any combinations of the preceding protocols, or any other suitable type of protocol.

The databases 16 on the server 12 can be of any suitable type. Preferably, the databases 16 are designed for efficient data access and manipulation both internally and externally in applications. The databases 16 are further designed for Internet applications and managing content, data and files including spreadsheets, word processing documents, Web pages, data forms, and email, and retrieve them either in native file format or in Hypertext Markup Language (HTML) format through the browser. The databases 16 are configured to provide enhanced security, search capabilities, back up and recovery, and establish an environment executable through a browser that enables the generation of Web content and pages dynamically. The client computers 36 include the same or similar hardware components as described for the server 12 and are each configured to facilitate networking with the server 12 via suitable communication links as described above. The client computers 36 are also equipped with suitable browser programs such as those offered by Netscape and Microsoft Corp. for facilitating access to and viewing of the web applications, data form templates, files, and databases, stored and maintained on the server 12.

The terms “quote advisor” and “technical manager” as used herein both refer to users authorized by a quoting company to prepare and process a statement of work for a customer and to select appropriate resources and access the company's business resource information to generate a quote for the customer.

The term “statement of work” refers herein to a collection of data representing details, resources, costs, and requirements for a particular project, and serves as a basis for generating a quote.

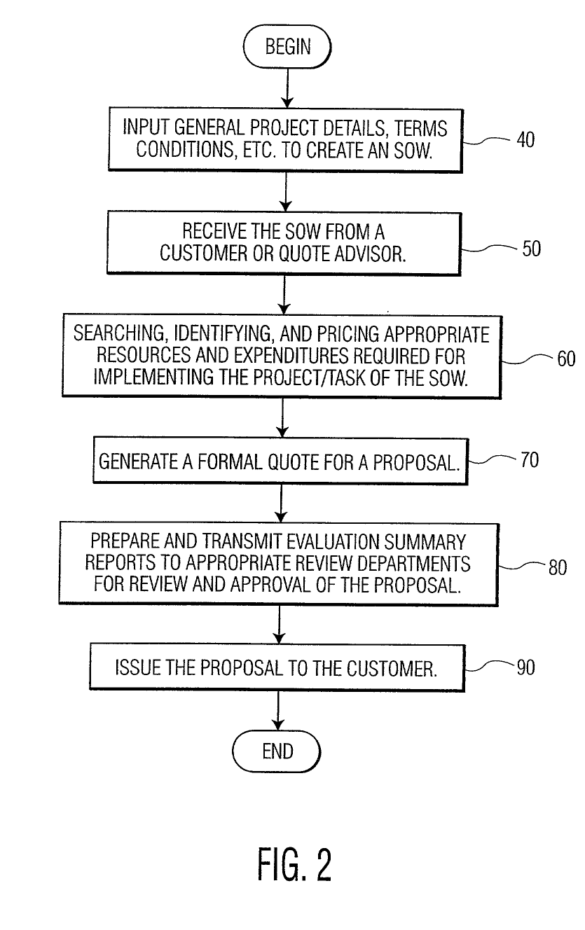

Referring to FIG. 2, there is depicted a flow chart detailing the general steps of the present invention. As indicated at step 40, the system 10 of the present invention allows a quote advisor of a company in consultation with a customer to prepare a statement of work (SOW). The statement of work outlines the requirements and details for a project or task including conditions, terms, time schedules, and the like. Once the requirements are inputted into the SOW, it can be submitted to the company through the system 10 for processing and review. The company receiving the SOW at step 50, initiates the quote forming process.

In another embodiment of the invention, the system 10 at step 40 can be further adapted to enable a customer or a business representative consulting the customer, to prepare a tentative statement of work and generate a rough order of magnitude (ROM) or tentative estimate detailing an approximated price for a project as defined by the tentative SOW. The tentative statement of work defines the project or task in general terms including requirements, time schedule, material, labor, travel, and the like. If the generated ROM satisfies the customer, the customer can submit the corresponding tentative SOW to the company and initiate the quote forming process. The data previously inputted by the customer into the tentative statement of work is subsequently incorporated into a formal SOW. Once submitted for formal quoting, the company receiving the customer's SOW at step 50, assigns the SOW to a quote advisor or technical manager for processing to prepare a quote as will be described hereinafter.

As indicated at step 60, the quote advisor reviews the SOW and inputs any necessary information that may be absent. Once all the information is inputted, the quote advisor proceeds to search, identify, select, and price the appropriate business resources such as materials, labor, travel, projected expenditures, equipment, and other costs that satisfies the requirements of the project while ensuring that the company's financial expectations are maximized. The projected costs and expenditures are also determined in this step. The business resource and expenditure information detailing the selected resources and costs are added to the statement of work. A formal quote is generated from the formal SOW to yield a proposal as indicated at step 70.

An evaluation summary report disclosing specific analyses and details of the proposal, for example, profitability, contractual compliance, delivery requirements, manufacturing requirements, and the like, is prepared and transmitted to the appropriate review departments of the company as indicated at step 80. Through the system 10, the review departments can each review and analyze the proposal online to verify its compliance with business standards sanctioned by the company. Each department can provide its respective approval by granting its electronic signature or stamp in association with the reviewed proposal. Upon gaining the required electronic signatures, the system 10 proceeds to prepare the transmission of the approved proposal to the customer for acceptance as indicated at step 90. If the proposal is rejected, the quote advisor is notified and informed of the grounds for rejecting the SOW and the quote. The system 10 can be further configured to include a metrics management routine for monitoring, tracking and measuring the time for processing the SOW at each stage and transmitting appropriate email notifications to relevant parties at each stage of completion.

The present invention provides a means to facilitate the flow of business information within a company and between the company and its customers. The system for implementing the method of the present invention is generally adapted to implement at least one mode of operation. In one mode of operation, a user (e.g., customer) can access the system implemented by a company to prepare a tentative statement of work comprising general details of a project to generate a rough order of magnitude or a tentative estimate. The tentative estimate provides the user with a general cost figure for the project. The customer user can submit the tentative statement of work to initiate the quote forming process.

In another mode of operation, the company via company-authorized users such as a quote advisor or a technical manager can obtain information from the tentative SOW or prepare a new formal SOW through communications with the customer to generate a formal quote. The company-authorized users are able to view and manage confidential business resource information online from a centralized source to select suitable resources for the project as defined by the SOW. Once a formal quote is generated, the formal quote is reviewed online by one or more review departments of the company. Upon approval by all the review departments, the formal quote is transmitted to the customer for approval.

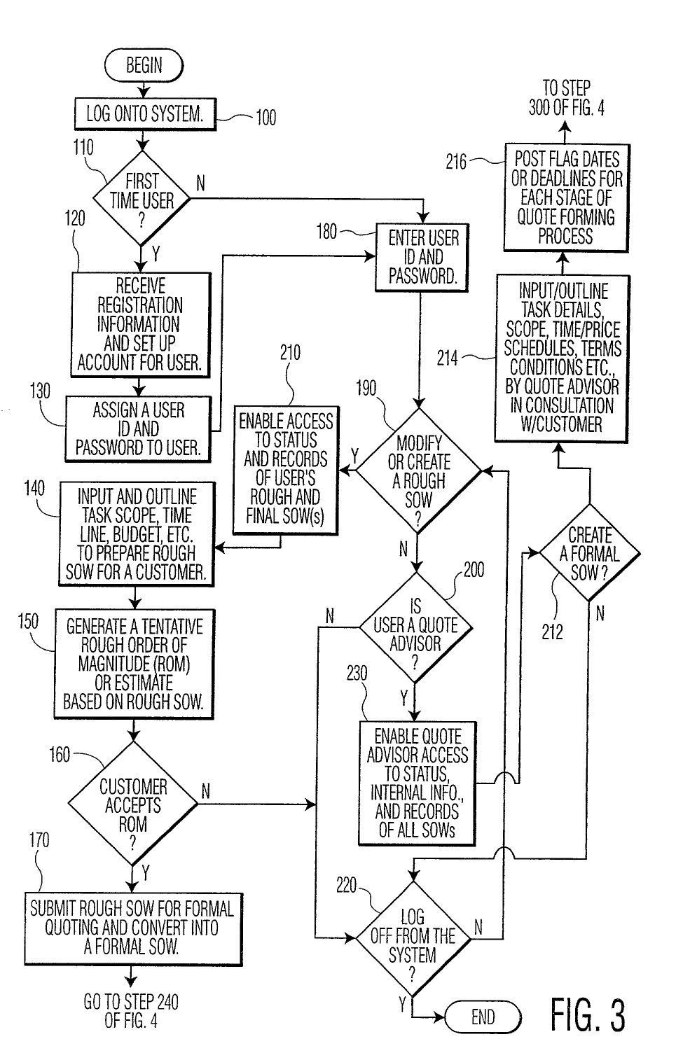

With reference to FIGS. 3 to 5, a flow chart is shown which illustrates the method carried out by the server 12 of the present invention. In a preferred embodiment, a user can access a client computer 36 to operatively connect with the server 12 via communications links 30 or 32. The server 12 is adapted to be selectively accessed by registered users each of which are classified according to a particular user class, i.e., business representatives, company personnel or employees, quote advisors, technical managers, customers, reviewing managers, and the like. Each user class is assigned with specific access and editing rights for specific data and information stored and maintained on the server 12. In this manner, any unauthorized entry or improper disclosure of confidential information is averted or at least substantially minimized. For example, access by a customer user is typically limited to creating, modifying, viewing, and submitting SOWs of the respective customer user; viewing and selecting generalized pricing schedules for an SOW; and generating a tentative estimate for the SOWs created by the customer.

With specific reference to FIG. 3, a user is required to log into the server 12 through one of the client computers 36 to initiate access to the system 10 as indicated at step 100. The server 12 is typically configured to implement a password security routine to authenticate and verify the user's identity in order to furnish access rights and to prevent unauthorized access. The password security routine queries to determine whether the user is accessing the server 12 for the first time, as indicated at decisional step 110. If the user has been previously registered, the user is prompted to enter a personal user identification code and a password code associated with the User ID to gain access to the server 12 as indicated at step 180. FIG. 3 does not illustrate additional steps for repeating requests for a password code if the user enters incorrect data, as these additional steps are known.

If the user is accessing the server 12 for the first time, the user is prompted to register and set up a new account as indicated at step 120. In connection with setting up a new account, the user is requested to provide prerequisite information for establishing proper identification of the user including name, address, organization, title, email address, telephone number, and the like. A range of data can be entered at step 120 and is not limited to the types listed above. Company personnel and employees and customers can register with the server 12 using this routine. Upon inputting the prerequisite information, the user can select a personal user identification code, or User ID, comprising a string of alphanumeric characters, for example, the user's last name and first initial, to identify a user account, and an alphanumeric password code corresponding to the User ID for gaining access to the server 12 as seen at step 130. Alternatively, the server 12 can be programmed to assign a User ID and password code to create the user account for the user. Once the user account is set up, the user can access the server 12 by entering the User ID and corresponding password code as indicated at step 180.

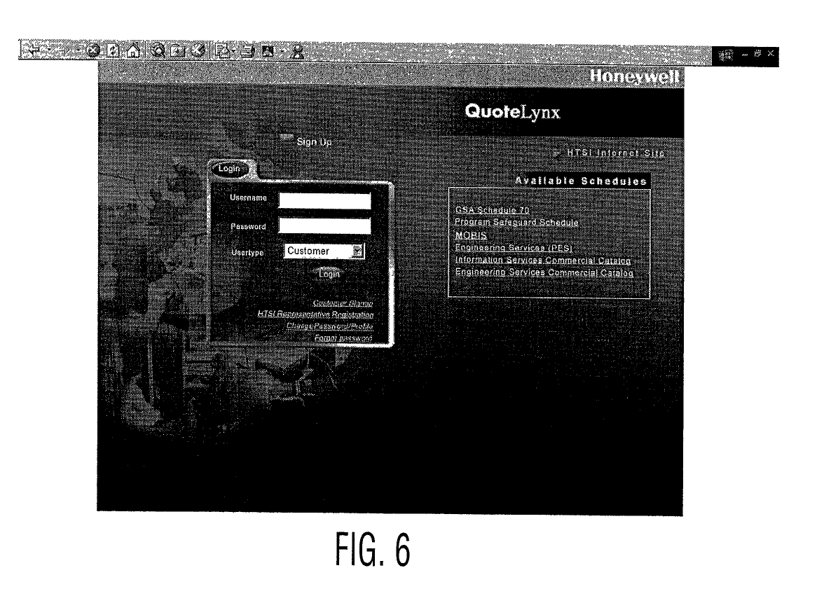

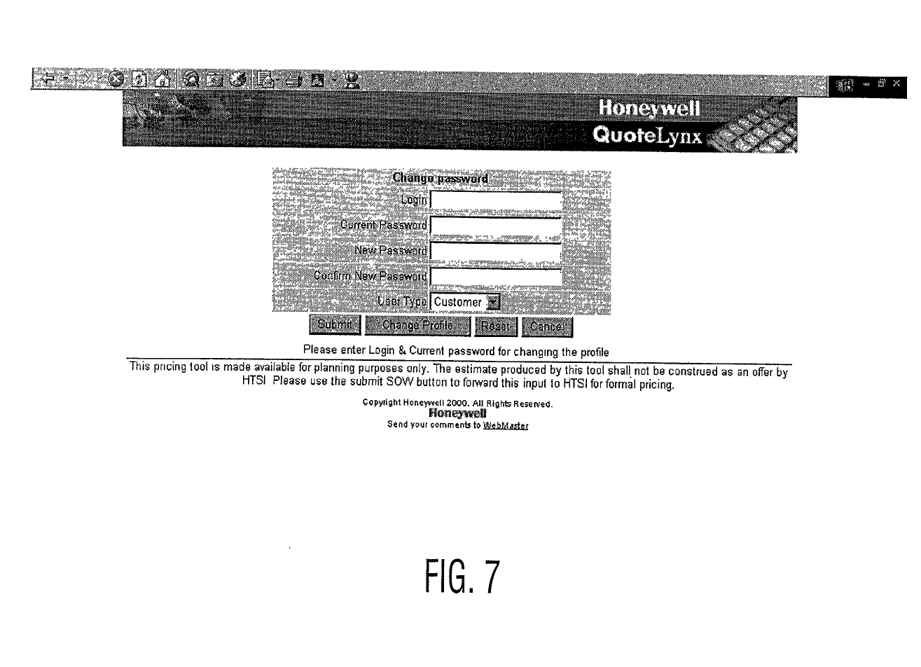

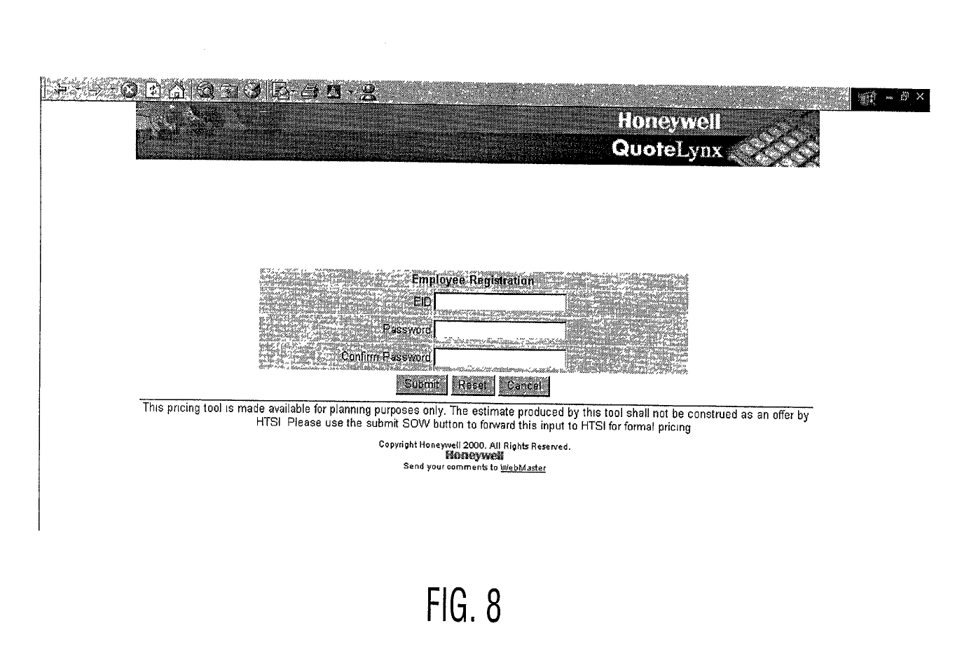

An example of a login view screen that can be employed according to the principles of the invention is shown in FIG. 6. The login view screen of FIG. 6 includes data fields for inputting a username or User ID, a password code, a user type (i.e., customer or company personnel), and a login icon button to submit the inputted data in the data fields. The login view screen further includes hypertext links for directing new customer sign ups, personnel registration, update for user profiles, and information relating to available schedules. The term “schedule” as used herein refers to specific listing of standardized pricing for services and goods offered by the company. With reference to FIG. 7, an example of a “Change Password” view screen is shown for allowing users to change password codes as required which is displayed upon activating the “Change Password/Profile” hypertext link on the view screen of FIG. 6. The view screen of FIG. 7 also allows the user to modify data corresponding to the user's profile. Referring to FIG. 8, an example of an “Employee Registration” view screen is shown which allows new employee users to register for a new user account.

Referring back to FIG. 3, once the user enters a valid User ID and corresponding password code at step 180, the server 12 proceeds to step 190 to query whether the user wishes to create a new rough or tentative statement of work or modify an existing one stored in the database 16. If the user chooses to create a new rough or tentative statement of work or modify an existing one stored in the database 16, the server 12 proceeds to step 210, otherwise it proceeds to decisional step 200 as will be described hereinafter.

At step 210, the server 12 enables the user to access for viewing all SOWs tentative and formal that are associated with the respective user. The user can view the details and the respective status of each SOW and the history of actions made on the corresponding SOW. The user can modify an existing SOW selected from ones stored on the database 16 or create a new tentative SOW. The user can input data into the SOW through one or more data form templates. Each of the data form templates for the SOW can contain data fields, pull-down menus, command icons for directing an action, and hypertext links for displaying a particular web document linked therewith.

Once the user has made a selection, the server 12 proceeds to step 140 that allows the user to input details and data into a tentative SOW. The user enters general details of the task or project for performance by the company. The details for the tentative SOW can include specifications of the project, time schedules, location of project, pricing schedules, payment options, labor requirements, materials, travel, and other direct costs. The user can input the details in general or itemized forms depending on the information available. Comment fields are provided for permitting the user to enter information that cannot be accommodated in the other data fields.

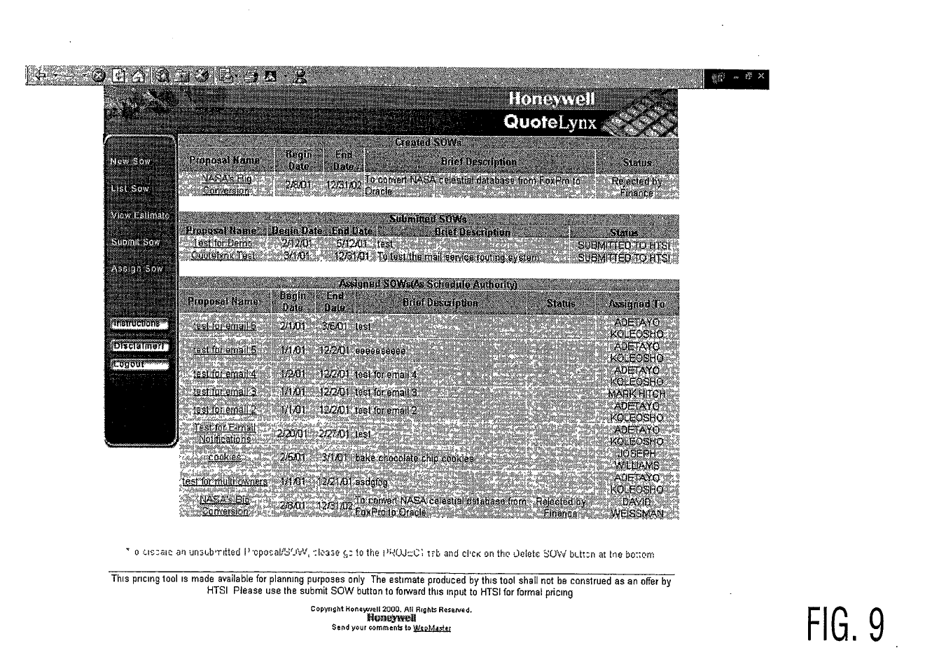

An example of an SOW list view screen for managing the SOWs created by the user that can be employed according to the principles of the invention is shown in FIG. 9. The SOW list view screen of FIG. 9, displays the name of each SOW, begin and end dates, brief description, status, and assignment of the SOW. The view screen of FIG. 9 arranges the SOWs into three groups: Created SOWs, Submitted SOWs, and Assigned SOWs. The view screen of FIG. 9 further includes a sidebar panel section to provide hypertext links that appropriately enables the user to create a new SOW, list all SOWs, view estimates, and assign an SOW to a quote advisor.

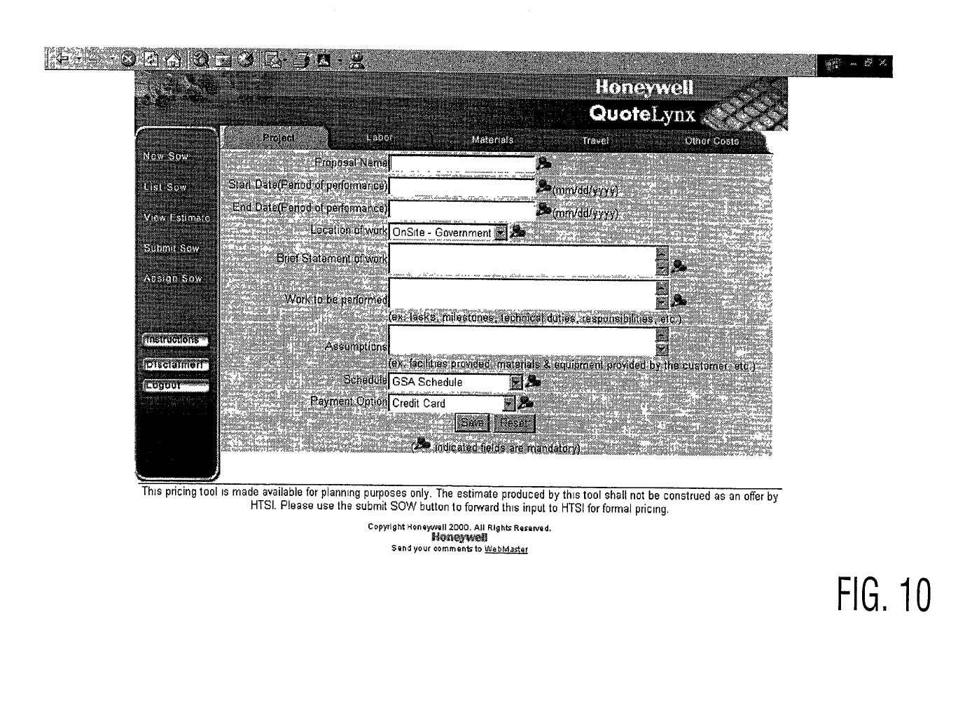

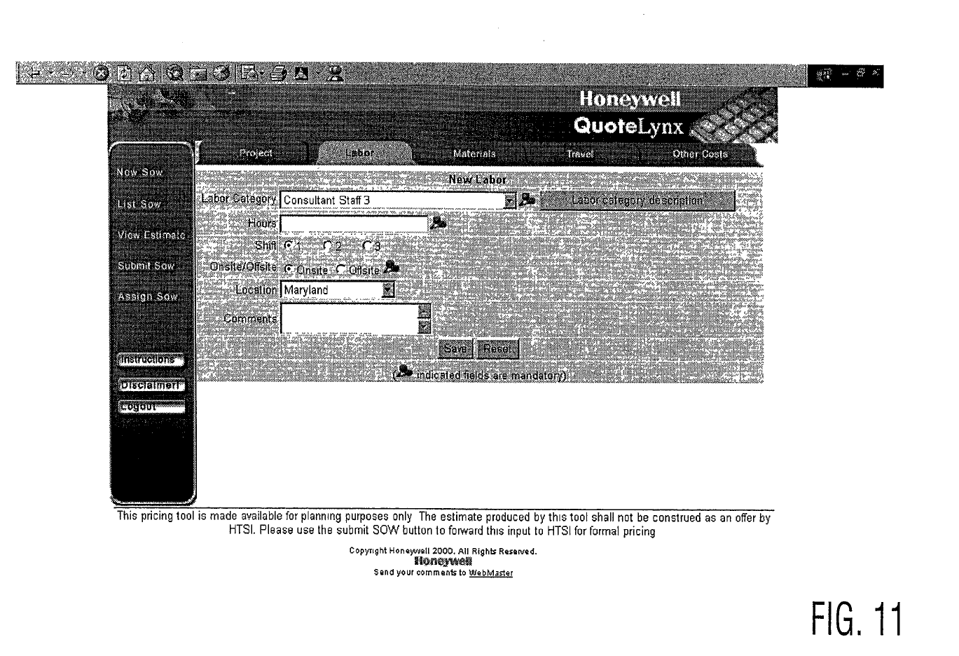

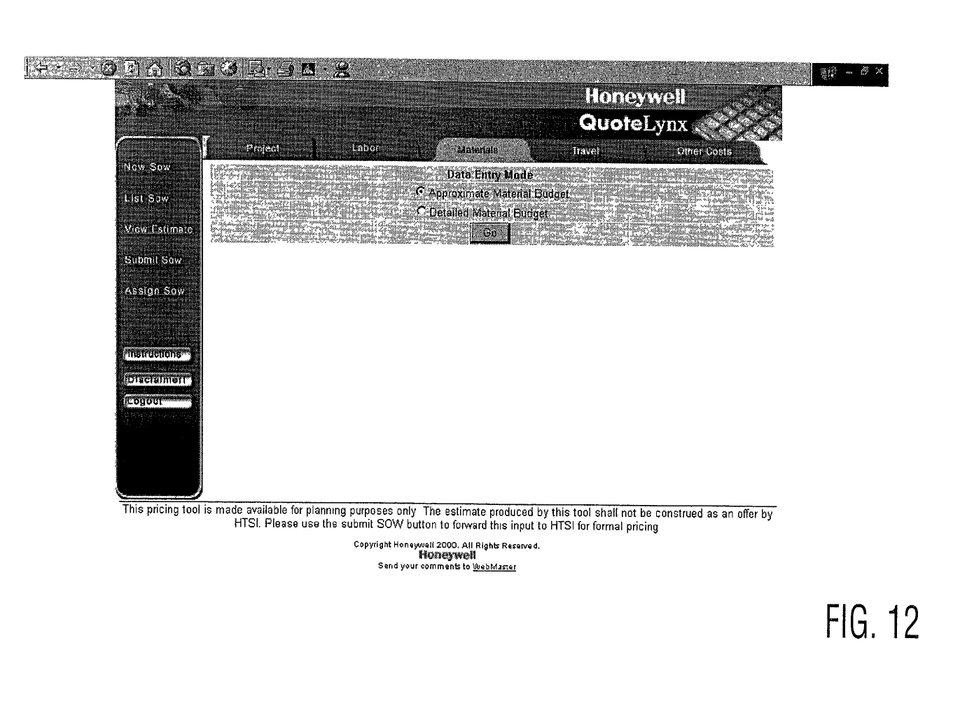

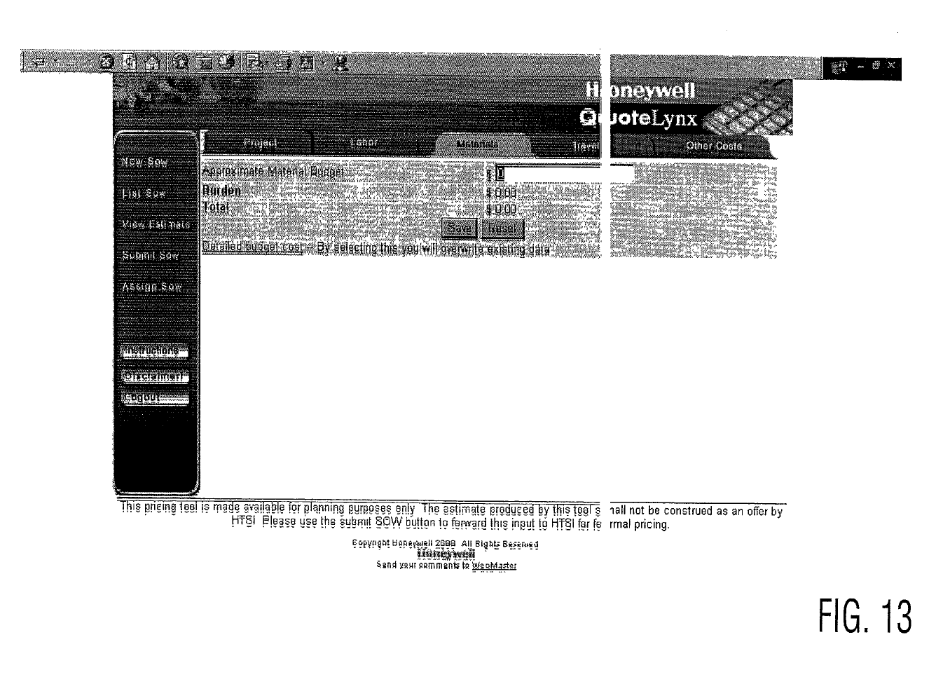

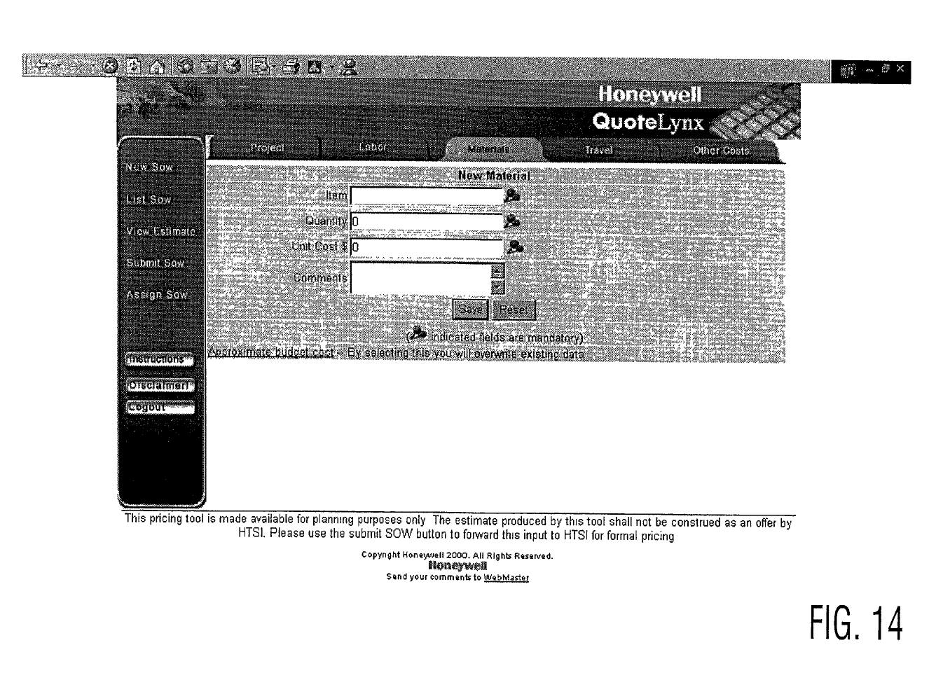

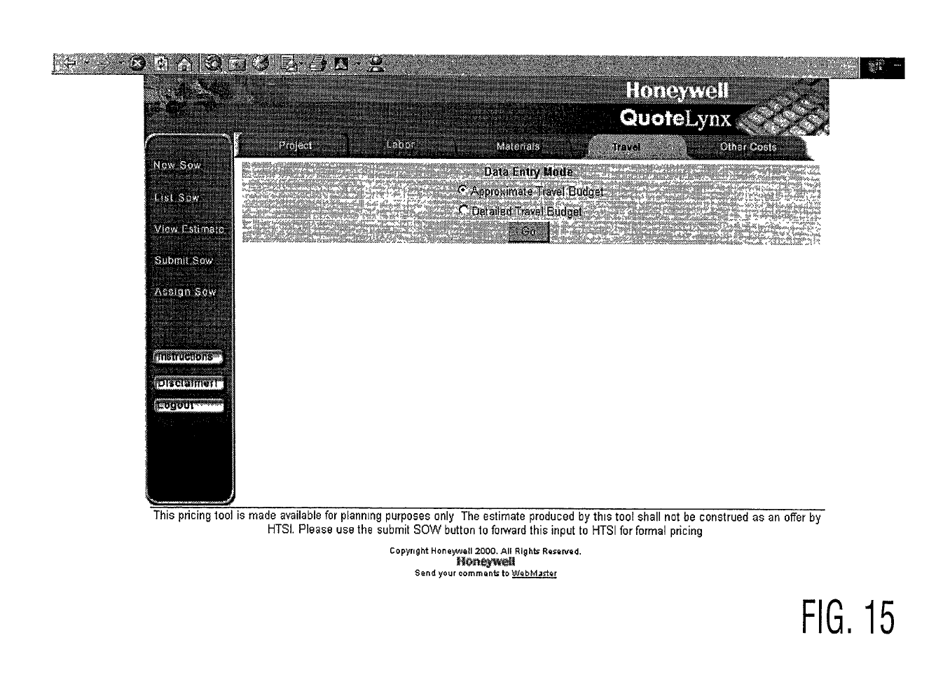

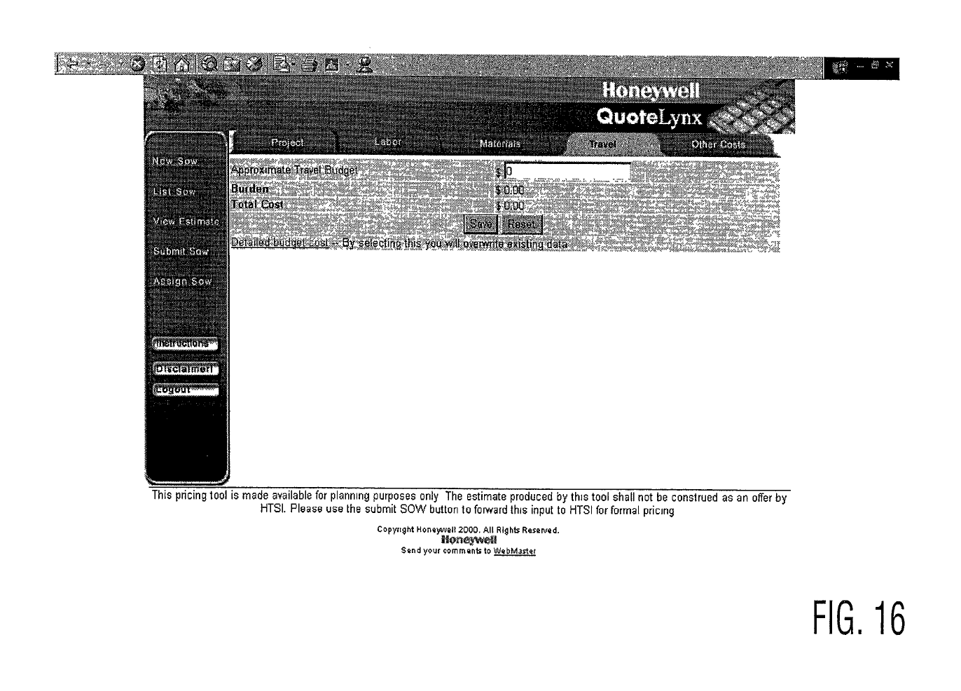

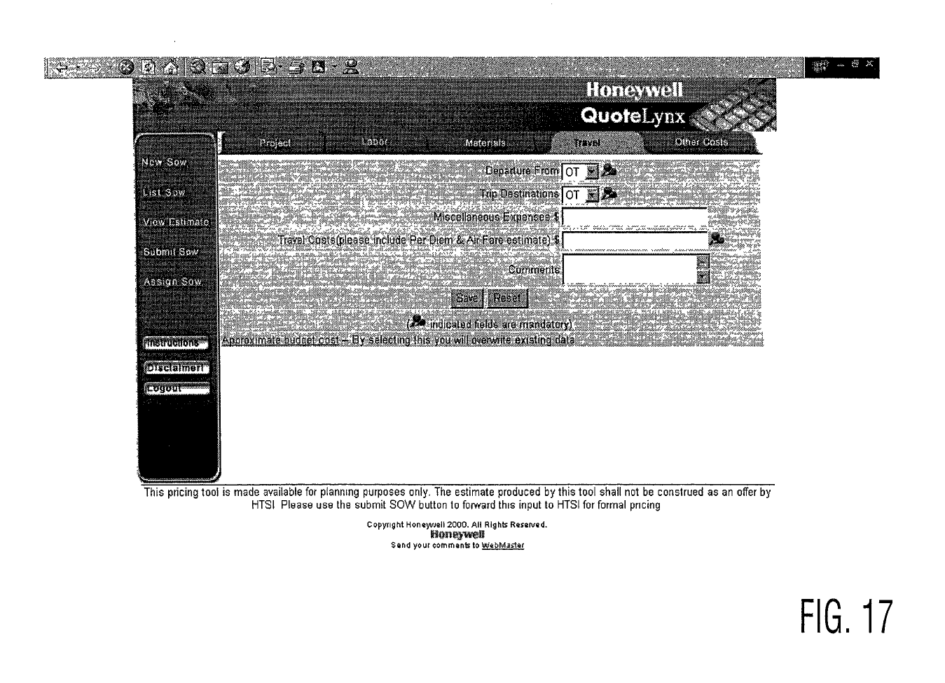

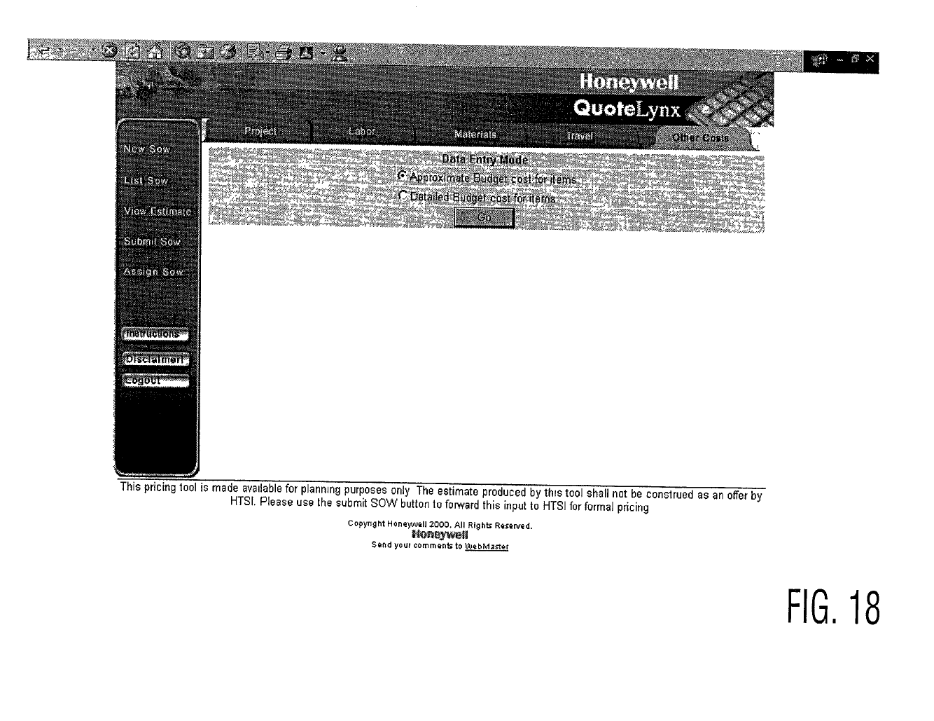

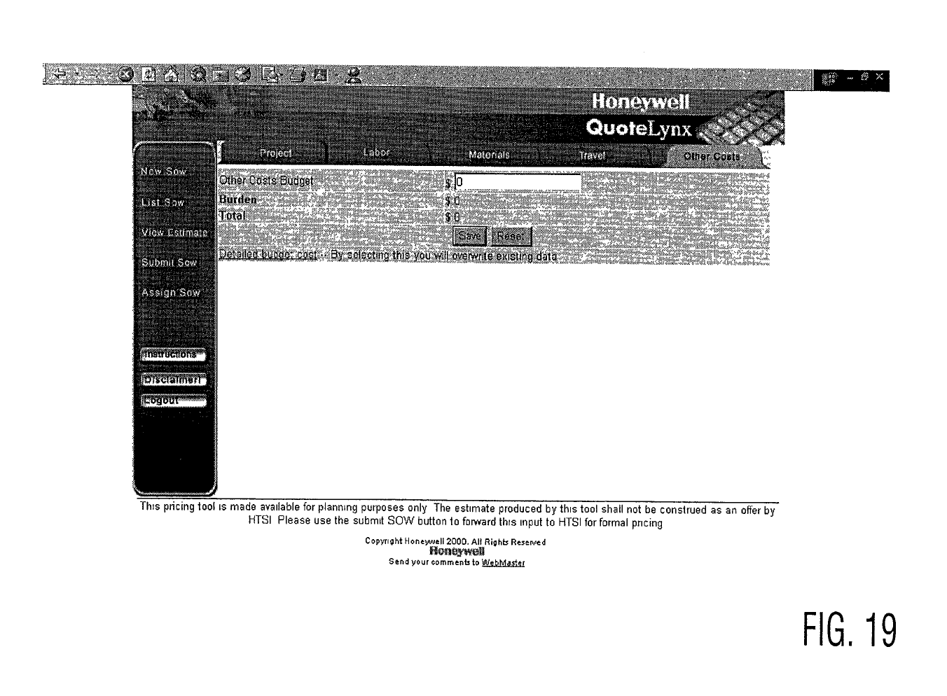

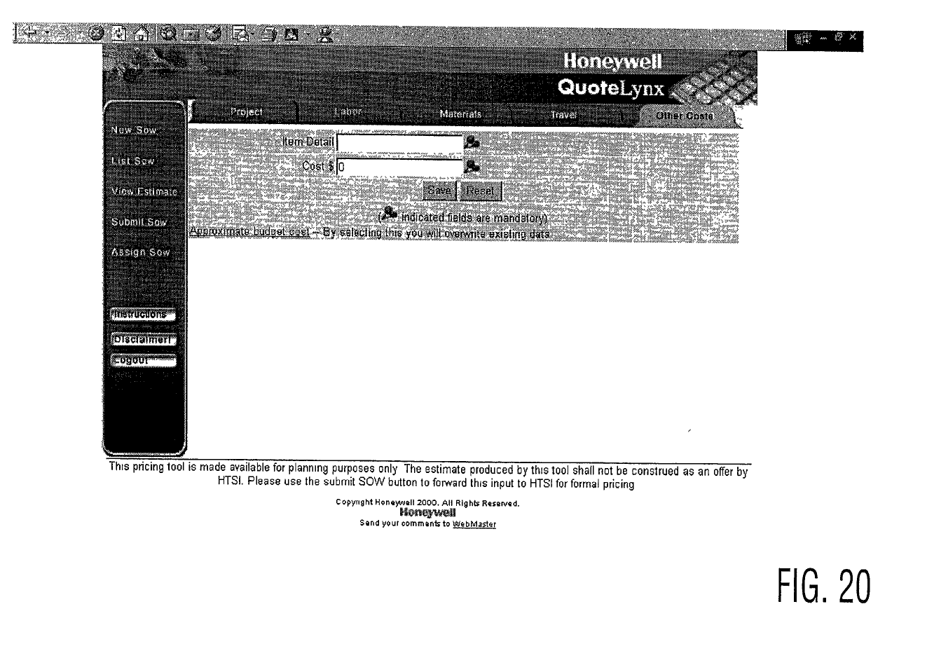

Examples of view screens that can be employed according to the principles of the invention are further shown in FIGS. 10 through 20 to allow a user to input details and requirements for preparing a tentative SOW as indicated at step 140 of FIG. 3. The details inputted into each data form templates illustrated by the view screens of FIGS. 10-20, each respectively corresponding to labor, materials, travel, and other costs, for example.

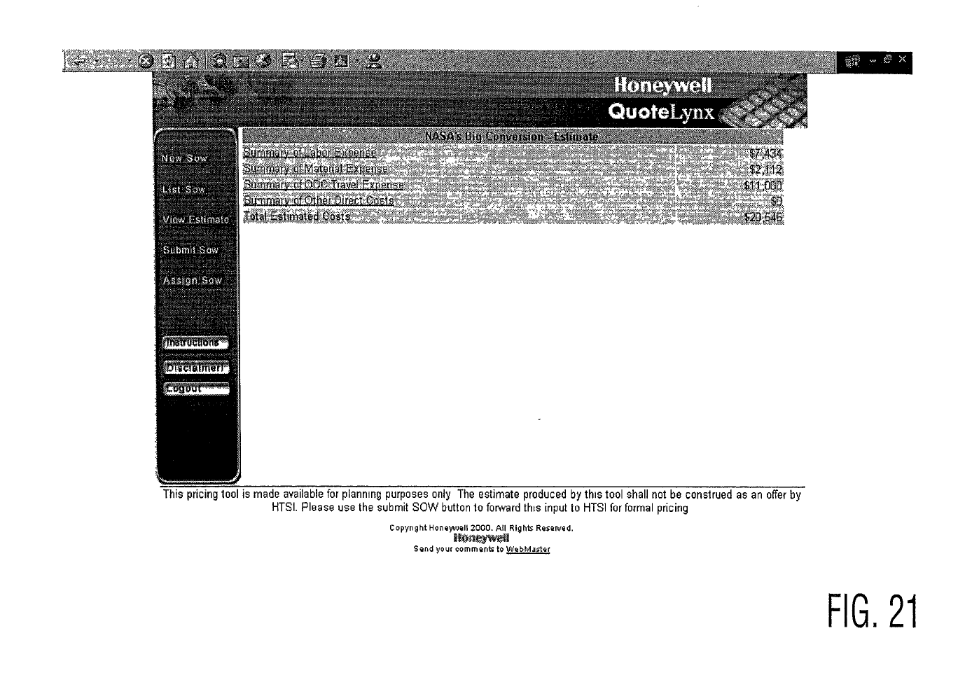

Referring back to FIG. 3, once the user completes the task of inputting the details into the tentative SOW at step 140, the tentative SOW can be saved into a temporary database for storage and later retrieval by the user until it is deleted, or formally submitted to the company for quoting whereupon it is saved in a permanent database. When the user completes the tentative SOW, the user can choose to view a price estimate corresponding to the project defined in the SOW. The server 12 proceeds to step 150, where the SOW is processed to generate a rough order of magnitude (ROM) or a tentative estimate based on the information inputted by the user at step 140. The generated ROM is displayed to the user for review. A ROM details the approximate costs for completing the project as defined in the tentative SOW and typically would not constitute a firm offer to the customer. The ROM can detail the costs for labor, material, travel, costs and the like identified along with the total estimate figure. An example of an “Estimate” view screen that can be employed according to the principles of the invention is shown in FIG. 21. The view screen of FIG. 21 specifically lists the prices for the labor expense, the material expense, the travel expense, and other direct costs along with a total estimate cost tallying the prices. The user can also view a summary of the costs for each item through activation of the corresponding hypertext links.

Referring back to FIG. 3, the server 12 proceeds to step 160 to determine whether the estimate displayed meets the customer's expectations. If the customer is not satisfied with the estimate, the server 12 proceeds to decisional step 220 to determine whether the user wishes to log off from the server 12. If the user does not wish to log out of the server 12, the user may choose to modify or create another SOW as indicated at decisional step 190 whereupon the process may be repeated.

If the ROM is within the customer's expectations, then the user can submit the tentative SOW to the company for formal quoting of the task or project as indicated at step 170. The transmission of the tentative SOW to the company is preferably done via e-mail but can be accomplished using any type of communication protocol as known in the art. The data contained in the tentative SOW is downloaded into a formal SOW for processing by the company.

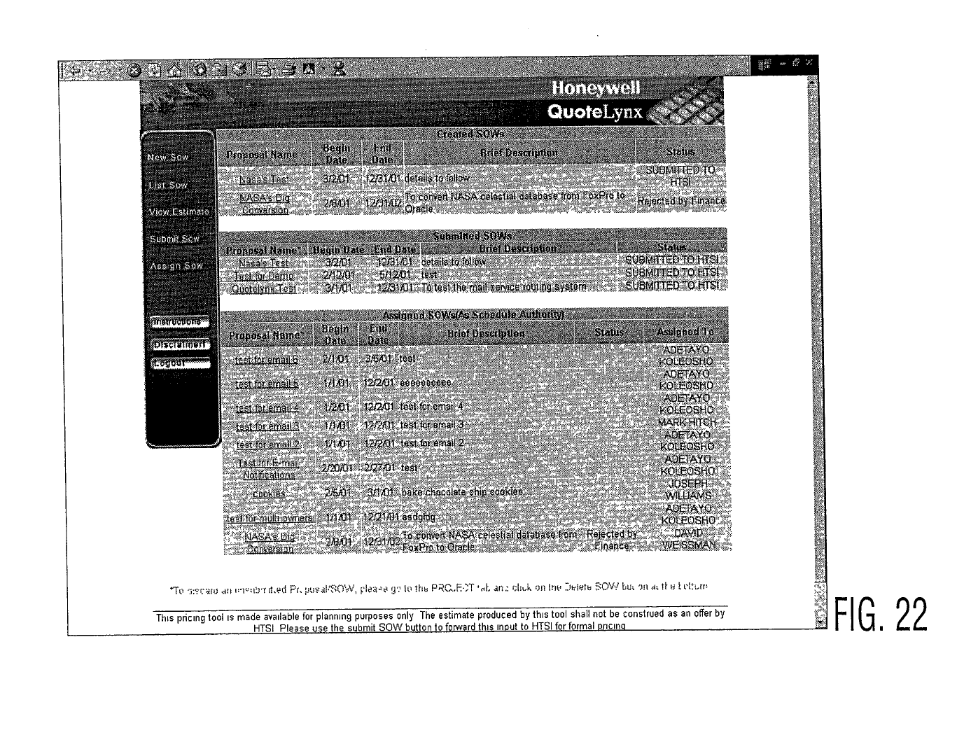

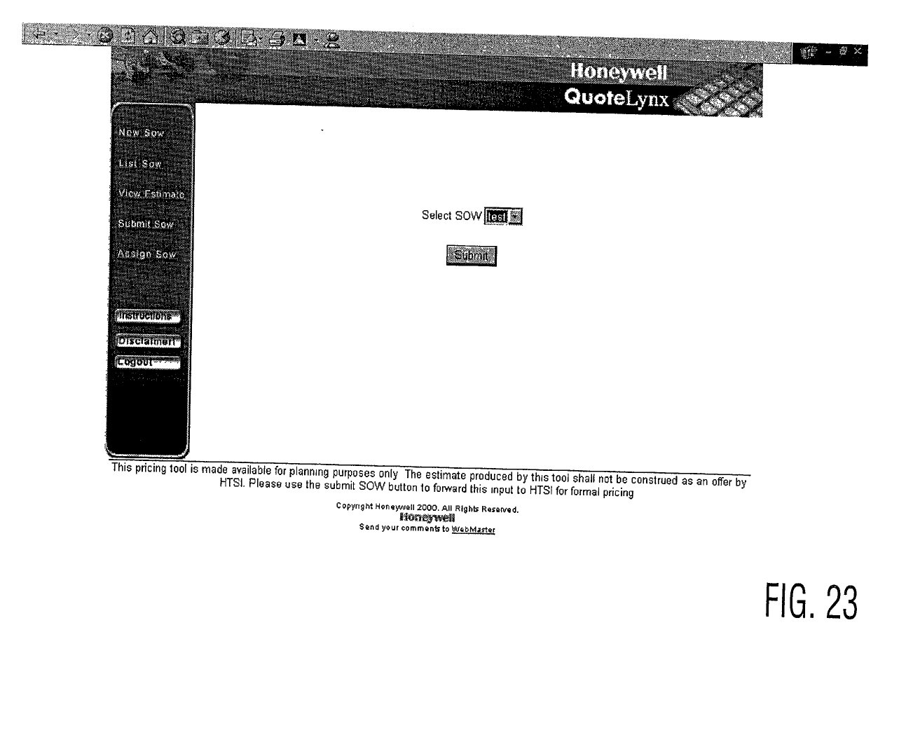

An example of an “SOW Submission” view screen that can be employed according to the principles of the invention is shown in FIG. 23. The view screen of FIG. 23 allows the user to select the SOW and submit the selected SOW by activating the “Submit” icon. Referring to FIG. 22, a view screen is illustrated which displays a listing of the SOWs created by the user to indicate and track the status of the newly submitted SOW.

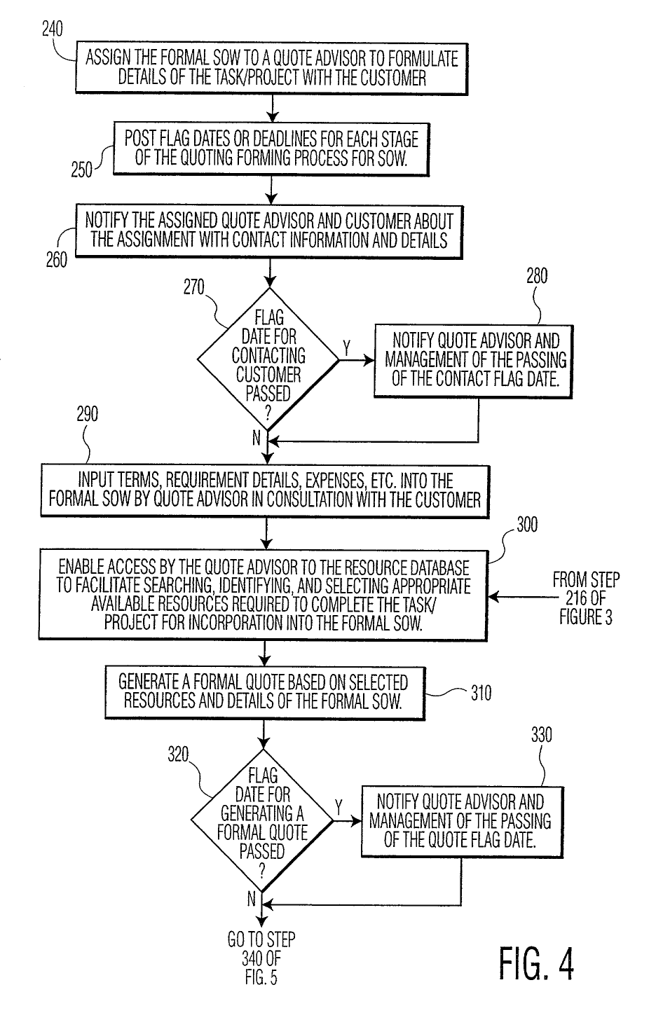

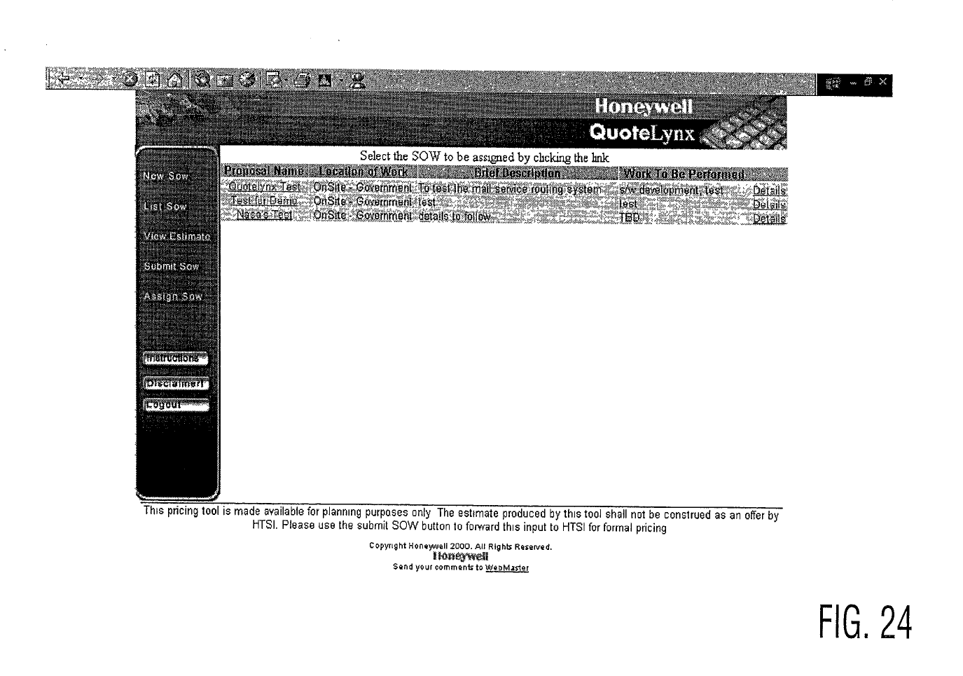

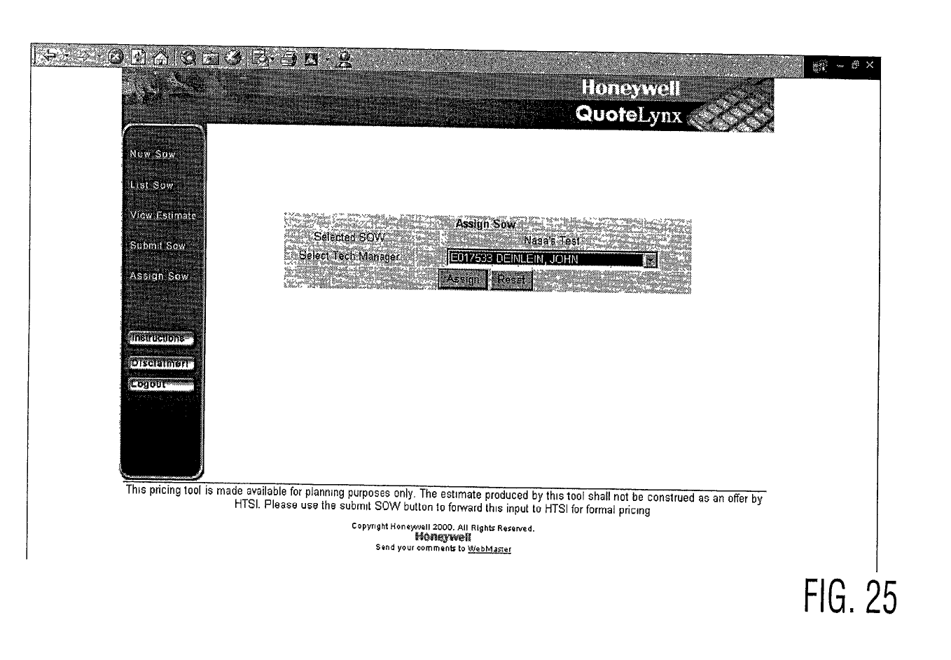

Referring to FIG. 4, upon submitting the SOW, the server 12 proceeds to step 240 wherein the submitted SOW is reviewed by a schedule supervisor for assignment to an appropriate quote advisor or technical manager. Alternatively, the server 12 can be configured to automatically assign the SOW to an appropriate quote advisor based on the details entered into the SOW. An example of an “Assign SOW” view screen that can be employed according to the principles of the invention is shown in FIG. 24. The view screen of FIG. 24 is accessible only by the schedule supervisor, or optionally, the quote advisor through activation of the corresponding “Assign SOW” hypertext link located in the sidebar panel of the view screen. The view screen of FIG. 24 displays a listing of the SOWs to be assigned. To assign an SOW, the supervisor is directed to select one of the SOWs listed by activating the corresponding hypertext link listed under the “Proposal Name” heading. Upon activating the appropriate hypertext link, the supervisor can select the suitable quote advisor for the selected SOW by activating the appropriate icon. An example of an “Assign” view screen that can be employed according to the principles of the invention is shown in FIG. 25. The view screen of FIG. 25 displays the selected SOW and directs the user to select the quote advisor or technical manager through the use of a pull-down menu listing suitable choices. Once selected, the user can activate the “Assign” icon to make the selection effective.

Referring back to FIG. 4, once the assignment of the quote advisor is made, the server 12 executes a programmed timer routine that generates flag dates corresponding to each predefined stage or event in the formal quote forming process. In the present invention, the flag dates function to ensure prompt processing of the SOW and avoids or at least substantially minimizes any delays in the process. The programmed timer routine monitors and tracks the progress of the SOW, while continuously updating and recording the occurrences of particular events or actions taken at each stage of the process. If, at any stage a flag date expires prior to taking a preset action, a notification routine is activated to inform the proper parties of the processing delay problem to initiate corrective measures. The notification routine can employ email communications to alert, for example, the quote advisor, supervisor, department manager/director and the like of the company. The use of the programmed timer and notification routines can eliminate or at least substantially minimize the incidences of a single point of failure in the process. Although the notification routine is described to be in the form of an email notification system, other forms of communication can be utilized for accomplishing the same purpose. It is noted that the notification routine can be further adapted to notify the relevant parties of any changes in the status of the SOW throughout the quote forming process.

Once the flag dates are generated and stored in the database 16, the customer and the quote advisor are informed of the assignment preferably via email. The notification can include contact information of the customer and the assigned quote advisor. A flag date for ensuring contact between the quote advisor and the customer is also monitored. At decisional step 270, the server 12 queries whether contact has been made before the flag date. If the date passes prior to making contact with the customer, the flag activates the notification routine and the quote advisor and management personnel are notified of the problem as indicated at step 280.

Otherwise, if the quote advisor successfully contacts the customer prior to activation of the notification routine, the server 12 proceeds to step 290 where the quote advisor is able to input data through a series of data form templates in the server 12 for outlining the more specific details and requirements of the project that were not inputted into the tentative SOW. Such data may include, for example, general information of parties, project description, contractual comments, and the like.

Referring back to FIG. 3, an alternate route for facilitating preparations of a formal SOW will now be described beginning at decisional step 200. At decisional step 200, the server 12 determines whether the user is a company-authorized user (i.e., quote advisor or technical manager) through a similar password security routine as described above. If the user is not a quote advisor or a similarly authorized employee, the server proceeds to step 220 where the user can choose to log off from the server 12 or to modify or create a tentative SOW back at step 190.

If the user is a quote advisor or similarly authorized employee, the server 12 is adapted to enable access of the database 16 for viewing the status, the open and confidential records of all the SOWs as indicated at step 230. The user can view a listing of SOWs and utilize a search engine to search for SOWs according to specific key terms, customer name, project or service type, quote advisor name, and other identifiers. It is noted that the company can assign specific levels of access to the database 16 for each employee user depending on, for example, the user's job function, position and title. Once the user completes searching of the databases 16, the server 12 proceeds to decisional step 212 to determine whether the user chooses to log off of the server 12 or modify/create a formal SOW as will be described hereinafter.

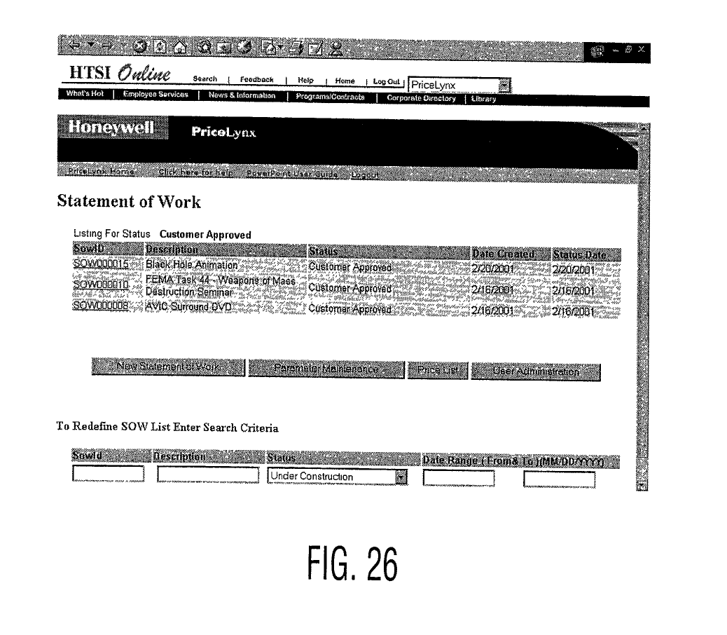

An example of a view screen showing a statement of work listing that can be employed according to the principles of the invention is shown in FIG. 26. The appearance and the details shown of the screen can vary depending on the user's class designation (i.e., customer, quote advisor, technical personnel, finance personnel, contracts personnel, administrator, or super user). For example, the customer user would only be able to view the listing information of SOWs created by the customer user, the quote advisor user is entitled to full edit rights to the content of the SOWs assigned thereto, and the finance personnel and the contracts personnel users can access only the summary reports of the SOW upon submission for approval or rejection and input accompanying comments for the decision.

The view screen of FIG. 26 enables the quote advisor to choose to view the status of the statements of work, to create a new statement of work, to modify an existing statement of work, or to review archives of past statements of work depending on the user's class designation. In addition, the user can create new statements of work incorporating data extracted from another previously prepared statement of work. The status information is maintained with the SOW in the database 16 and any changes in the status of the SOW are updated and recorded in the database 16 by the server 12. It is further noted that the server 12 is configured through the notification routine described above to notify the customer of all changes in the status of the SOW via email or other suitable communication means. In this manner, the customer remains informed of the SOW's progress throughout the process, thus preventing or at least minimizing the incidences of single point of failures. The status designations can include the following:

“Under Construction” refers to the status of the SOW that the quote advisor has begun entering data into the SOW, but the SOW is not complete and has not been submitted for approval by one of the review departments;

“Pending Finance Approval” refers to the status of the SOW that the quote advisor has submitted the SOW for approval by the finance review department;

“Rejected by Finance” refers to the status of the SOW with which the finance review department group has found a problem, which is correspondingly documented in the comments field in the screen;

“Pending Contracts Approval” refers to the status of the SOW that the finance review department has approved, and has submitted the SOW to the contracts review department for approval;

“Pending Customer Approval” refers to the status of the SOW that has been submitted to the customer as a project proposal for acceptance or rejection;

“Customer Approved” refers to the status of the SOW that the customer has approved or accepted the project proposal; and

“Customer Rejected” refers to the status of the SOW that the customer has disapproved or rejected the project proposal.

The statement of works list displays the identification number of the SOW (SowID), the description, the status, the date the SOW was created, and the date on which the last status was recorded. In this example, the corresponding data can be accessed and viewed by activating one of the hypertext links located in the “SowID” column. The view screen showing the statement of work listing includes a “New Statement of Work” icon button for creating a new SOW, a Parameter Maintenance icon button for updating pricing or rates on resources, local travel costs, etc., a “Price List” icon button for accessing and displaying pricing and rates of one ore more schedules, and a “User Administration” icon button for adding or deleting users, modifying access privileges and the like, and general housekeeping measures. The screen also includes a data field for a implementing a search engine to search and retrieve SOWs according to SowID, Description keywords, Status type, and date ranges.

Referring back to FIG. 3, at step 212, if the user chooses not to create or modify a formal SOW, the server 12 proceeds to step 220 where the user can log off from the server 12 or choose to modify or create a tentative SOW at step 190. If the user is identified as a quote advisor and the user chooses to modify or create a formal SOW, the server 12 proceeds to step 214 where the quote advisor inputs data through a series of data form templates in the server 12 for outlining the details and requirements of the project. Such data may include, for example, general information of parties, project description, contractual information, and any other information including deliverable schedule, acceptance criteria, applicable standards, special requirements and special allowances, comments, and the like.

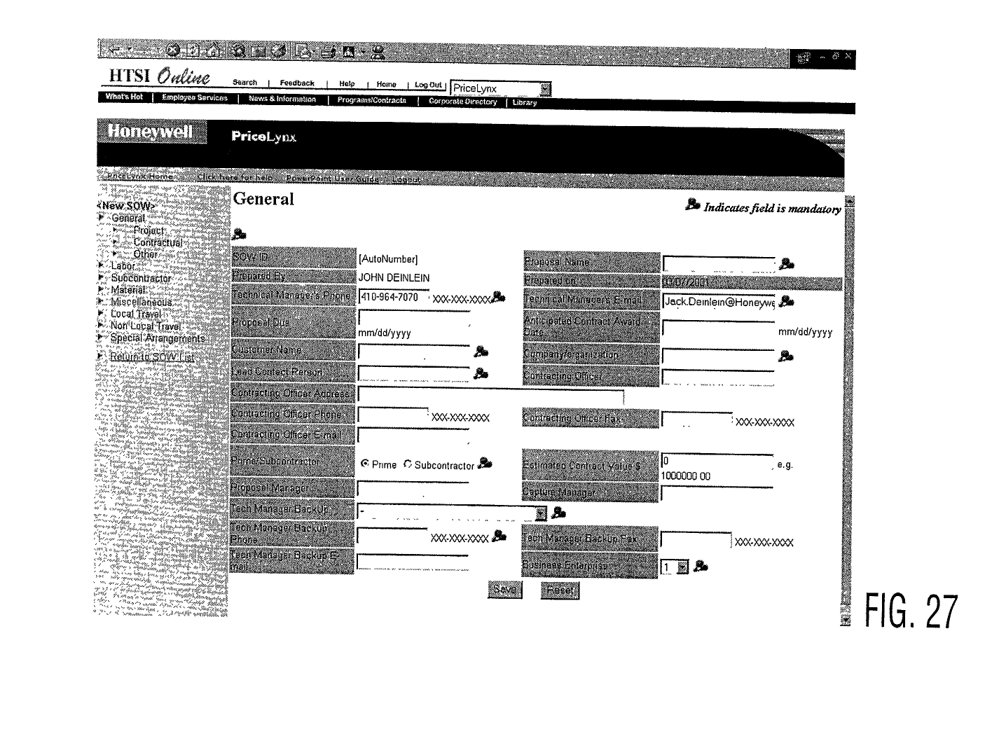

Examples of view screens that can be employed for the implementation of step 214 according to the principles of the invention, are shown in FIGS. 27 to 30. Referring to FIG. 27, a “General Information” screen is shown. The quote advisor is required to fill out the required data fields marked with a “Push Pin” Icon. The quote advisor enters all the data relating to the “General” information of the project for incorporation into the SOW. The information inputted into the SOW is processed for the preparation of the project proposal. The quote advisor reviews the information entered for accuracy and completeness. The quote advisor also has the option to “Reset” the screen which when activated, erases all the data previously entered for permitting re-entry. To save the data, the quote advisor activates the “Save” icon near the bottom of the view screen. Upon saving the inputted data corresponding to the “General Information” template, the server 12 automatically assigns an identification number for the SOW and proceeds to the next data form template. It is noted that the quote advisor must save any newly entered data each time the SOW is modified. The view screen of FIG. 27 can also include a data field for inputting the identity of a secondary or back-up quote advisor or technical manager who is also furnished with full editing rights of the SOW. The quote advisor is then directed to a succeeding view screen to enter further information in developing the details of the SOW. The quote advisor may return or advance to each data form template by activating the corresponding hypertext links located in the sidebar panel of the view screen.

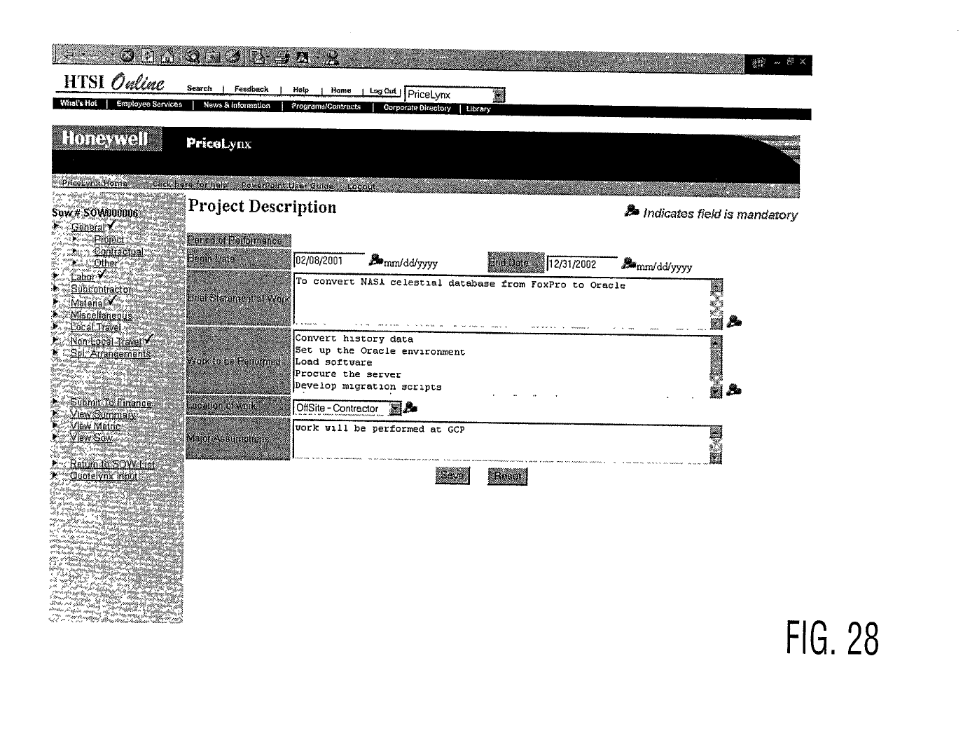

In FIG. 28, a view screen illustrates a data form template which enables the quote advisor to enter and save data relating to the “Project Description” as a section of the General information of the SOW. Data fields corresponding to the SOW include Period of Performance, Begin Date, End Date, Brief Statement of Work, Work to be Performed, Location of Work, and Major Assumptions. The Brief Statement of Work field is used to enter a concise description of the project, and is configured to accept up to 256 characters. The Work to be Performed field has a larger data capacity to accommodate a lengthy input for entering a more detailed description of the tasks to be performed in the project. The quote advisor can cut and paste the information from a text file into a field of the SOW. The quote advisor then reviews the information entered for accuracy and completeness prior to saving the data into the SOW. The quote advisor is then directed to a succeeding view screen to enter further information for developing the details of the SOW.

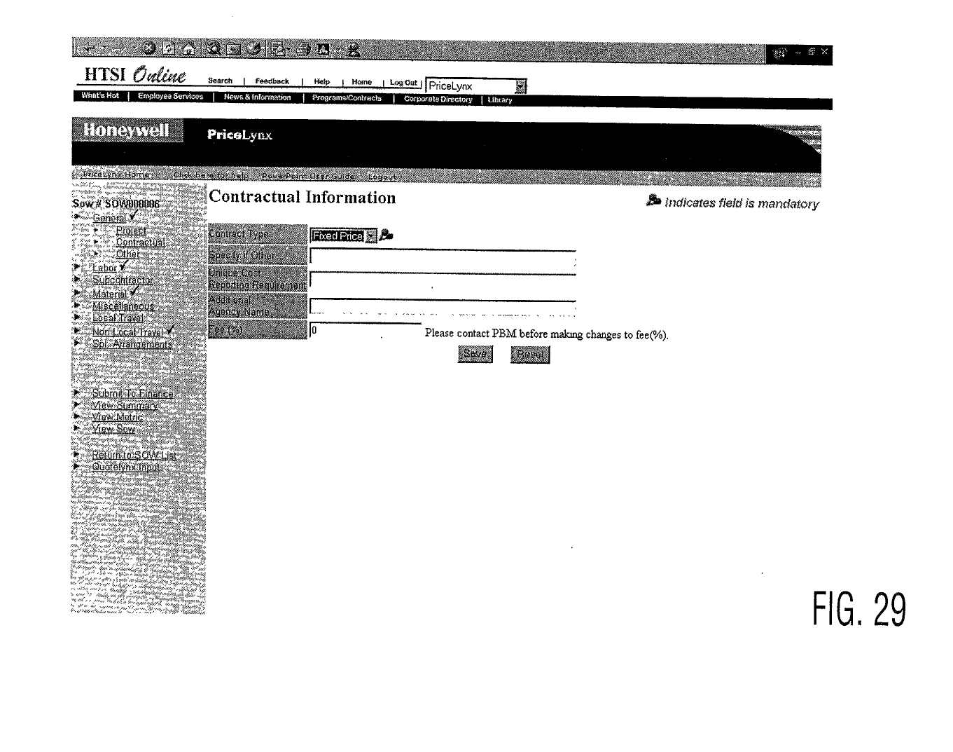

In FIG. 29, a view screen illustrates a data form template which enables the quote advisor to enter and save data relating to “Contractual Information” as a section of the General information of the SOW. The data form template comprises data fields including Contract Type (e.g., fixed price, time and material, level of effort, etc.), Specify If Other, Unique Cost Reporting Requirement, Additional Agency Name, and Fee (%). The series of data form templates can further include other data fields that may be relevant to the Contractual Information section. The quote advisor reviews the information entered for accuracy and completeness prior to saving the data into the SOW. The quote advisor is then directed to a succeeding view screen to enter further information for developing the details of the SOW.

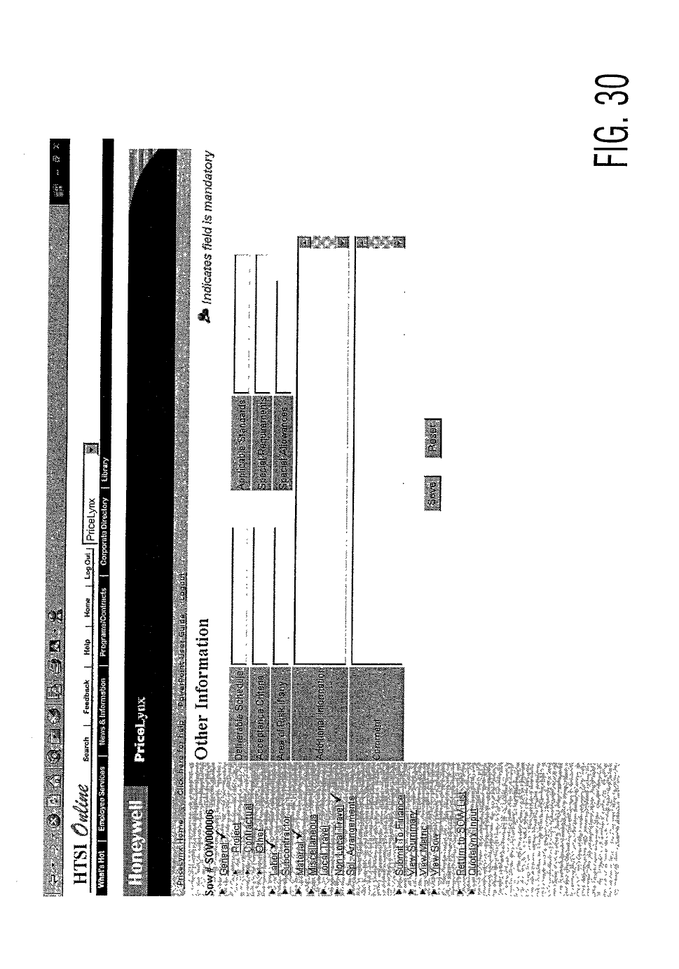

In FIG. 30, a view screen is shown illustrating a data form template that enables the quote advisor to enter and save data relating to “Other Information” as a section of the General information of the SOW. The quote advisor can enter information by way of text or data fields relating to Deliverable Schedule, Acceptance Criteria, Area of Risk, if any, Applicable Standards, Special Requirements, Special Allowance, Additional Information, Comment and any other pertinent information. The quote advisor then reviews the information entered for accuracy and completeness prior to saving the data into the SOW.

Referring back to FIG. 4, once the formal SOW is completed and submitted, the server proceeds to step 300 where the programmed timer routine generates flag dates corresponding to each predefined stage or event in the formal quote forming process as previously described above.

Once the formal SOW has been submitted to the company, the server 12 proceeds to step 300. It is noted that the route through which formal SOW is created from the submitted tentative SOW proceeds from step 290 of FIG. 3 to step 300.

At step 300, the quote advisor is able to access a resource identification tool (RIT) or alternatively, for employee assignment, an employee identification tool (EIT) for accessing a database 16 storing the corresponding business resource information. The resource information is arranged in one or more categories. The database stores information on each resource along with pricing thereof for viewing and selection by the quote advisor. Once selected and incorporated into the SOW, a running price tally of all of the resources selected by the quote advisor is maintained.

The resource identification tool utilizes a search engine that is designed to assist the quote advisor to find resource information stored on the database 16 based, for example, on skills, qualifications, and the like, which meets the requirements of the SOW. The search engine can search the resource information based on keywords or combination of keywords, or based on information categories such as resources including labor, material, travel, and the like, and other areas including direct costs or expenditures. It is not necessary to describe the particular details of the search engine since search engines are known in the art for organizing, indexing and searching information on a server or a network including the Internet.

Using the resource identification tool, the quote advisor can use the data gathered from the customer in the SOW to identify labor, materials, and the like that matches the criteria and their availability for the task or project from a central online source. Access to resumes and skill assessments are available for viewing online through the server 12 via document files associated with hypertext links corresponding to the resources displayed to the quote advisor. The quote advisor can communicate with resource personnel to verify and confirm availability via email or telephone.

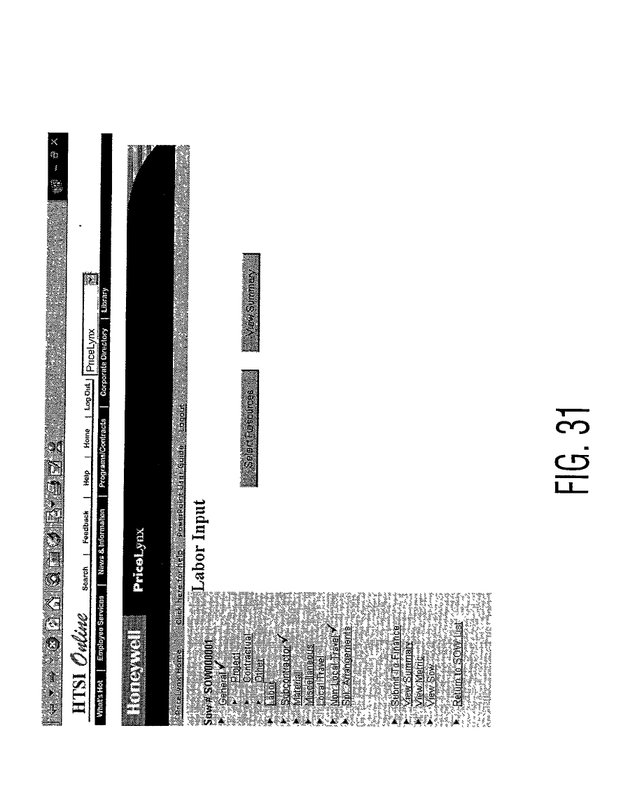

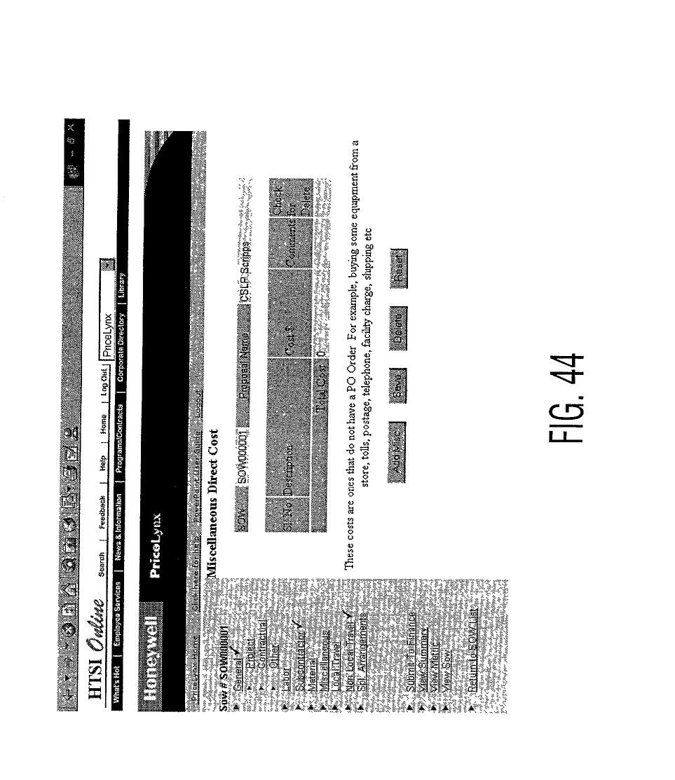

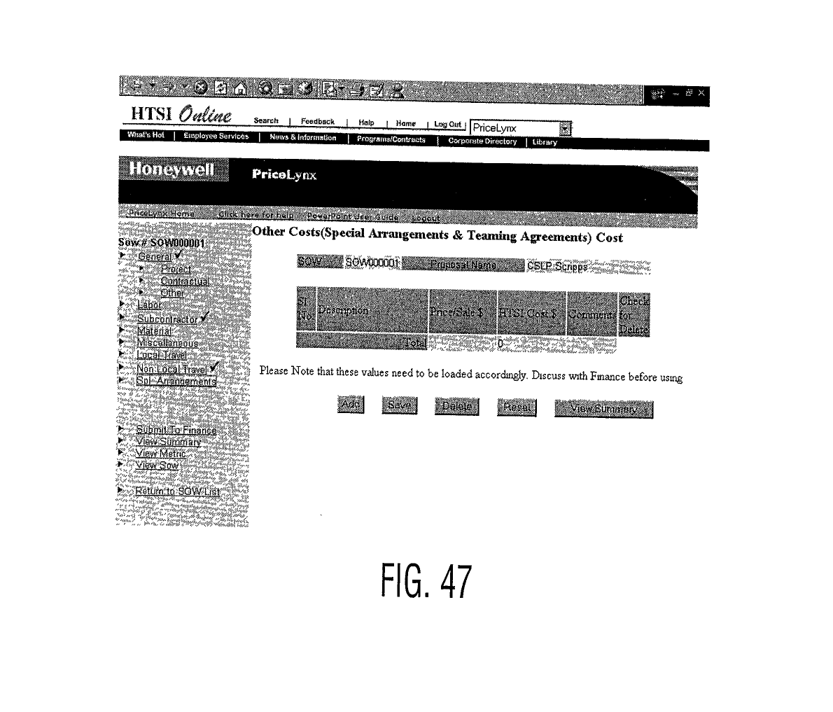

Examples of the view screens for implementing data entry by the quote advisor at step 300 are shown in FIGS. 31 to 47. A range of data may be entered at step 300 and not limited to the types listed above. The view screens shown in FIGS. 31 to 47 each refer to the identification and selection of resources including but not limited to labor, subcontractors, materials, miscellaneous, local/nonlocal travel, and special arrangements. It is noted that access to the identification and selection of resources tool is limited to internal use by authorized personnel of the company for processing the SOW.

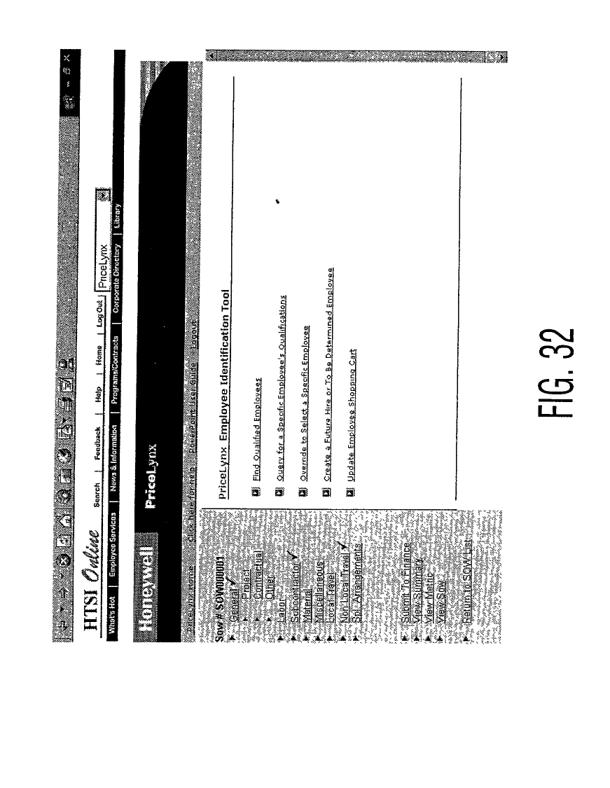

In FIG. 31, a view screen is illustrated which enables the quote advisor to select labor resources or view the summary of the Labor Input for the SOW. In FIG. 32, a view screen is illustrated for providing the quote advisor with options in the identification and selection of labor-related resources referred herein as an “employee identification tool” (EIT). The five options in the view screen are listed as follows: “Find Qualified Employees” which permits the quote advisor to locate qualified employees for the task or project of the SOW; “Query For Specific Employee's Qualifications” which allows the quote advisor to identify and select specific employees based on qualifications or labor categories; “Override to Select a Specific Employee” which allows the quote advisor to select one or more specific employees who have been verified for the prerequisite qualification based on known background and experience; “Create a Future Hire or To Be Determined Employee” which allows the quote advisor to model and price an employee that will be specified or hired in the future; and “Update Employee Shopping Cart” which allows the quote advisor to save and update information on employees selected for the SOW.

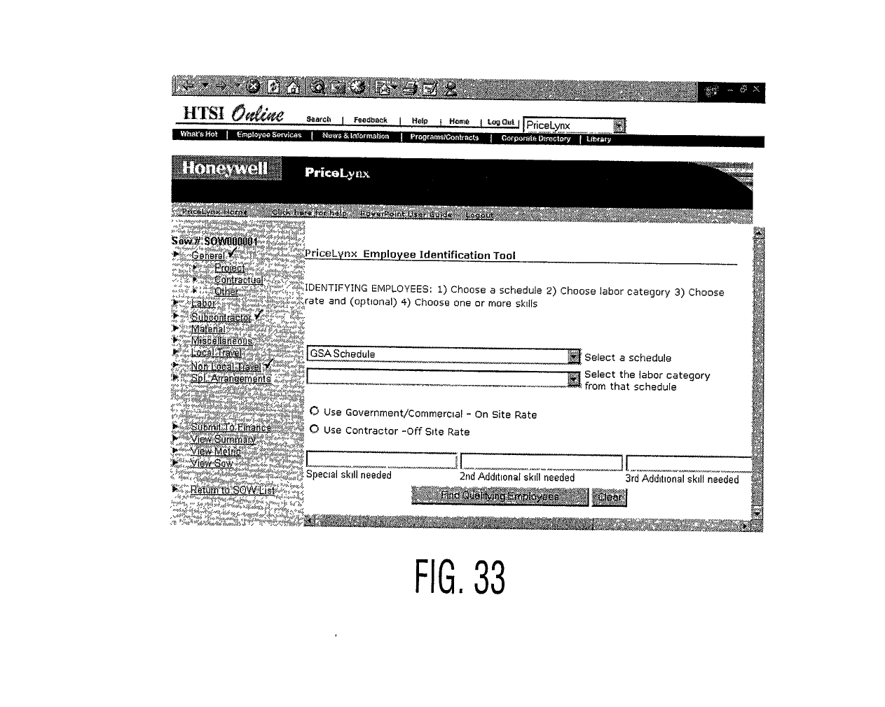

The EIT allows the quote advisor to seek the database 16 for qualified labor staff based on ascribed job codes for each employee organized into specific schedule labor categories. For example in FIG. 33, a sample view screen is illustrated where the quote advisor can select and input the labor schedule, the specific labor category of the schedule, the labor rate (i.e., on site rate or off-site rate), and any special skills. Once the qualifications are inputted, the quote advisor can prompt the EIT to find the employees satisfying the inputted qualifications. It is noted that the information and results obtained from the EIT are to be kept confidential by the quote advisor. The results include the relative “profitability” of the employee based on the salary and overhead burdens to the company in the form of return on sales ratings.

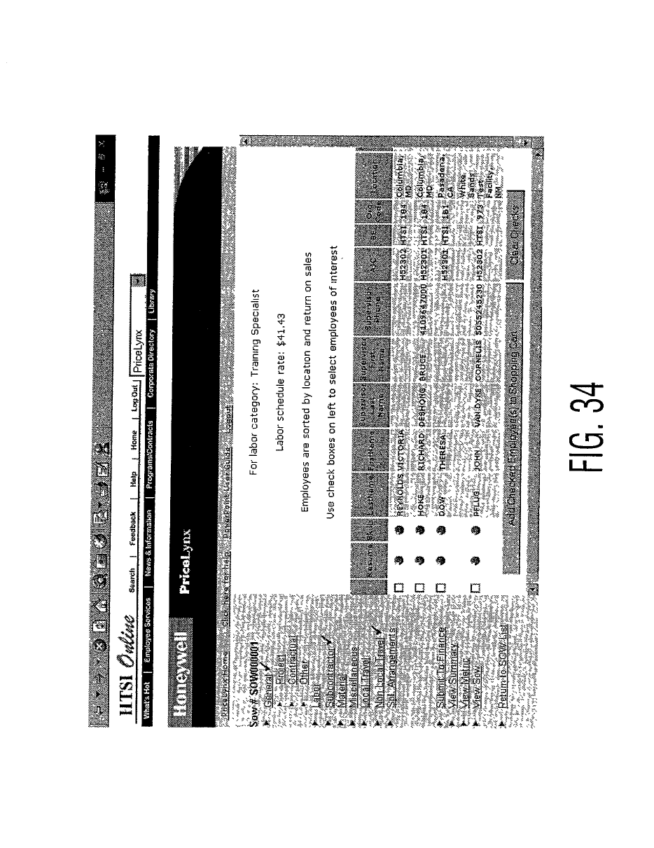

In FIG. 34, a sample view screen is illustrated to show an example of results generated by a search based on a labor category and schedule for the Find Qualified Employees option. The results identify the employees based on the labor schedule, the labor categories, whether the project is on-site or off-site, and other selected skills. The quote advisor can view the information of the employees listed including resumes, skills assessment, and the like. The quote advisor can select the employees by checking the box to the left of the employee to be selected and the name of the selected employee is saved into an employee bin or “shopping cart” for the SOW.

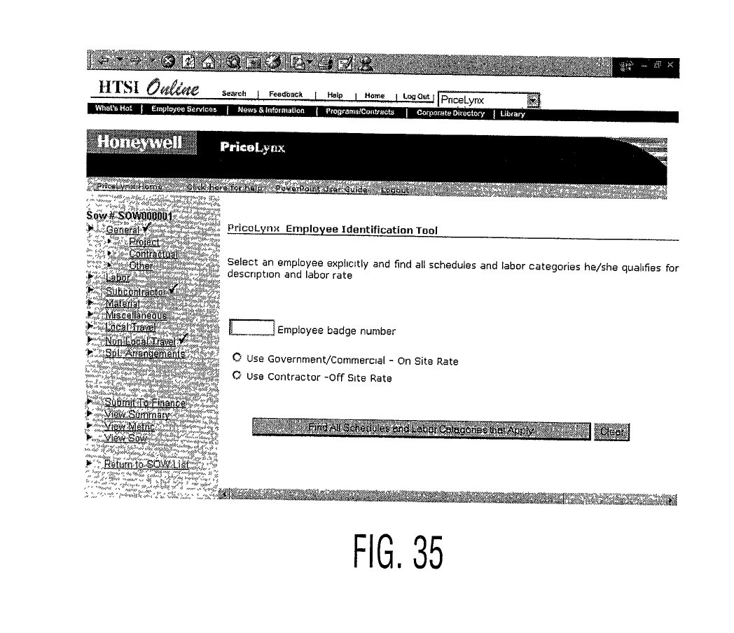

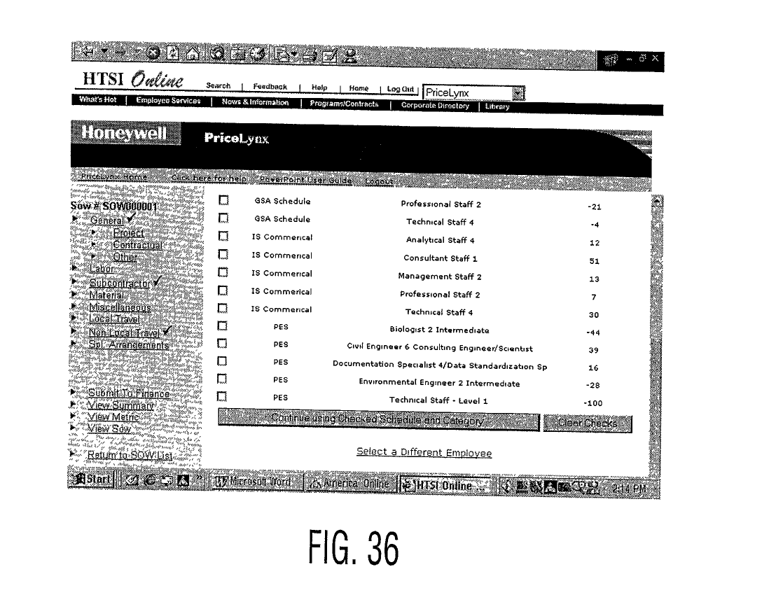

For the Query for Specific Employee's Qualifications option, the quote advisor can input a specific employee for searching and displaying the qualifications of the particular employee as shown in a sample view screen illustrated in FIG. 35. In the view screen of FIG. 35, the quote advisor inputs the specific employee's identification or badge number and whether the project is on-site or off-site. In a sample view screen illustrated in FIG. 36, a listing of the specific employee's qualifications is shown as an example. The results further display the schedule, labor categories, and qualifications for each of the specific employees inputted by the quote advisor. The quote advisor can then select the employee by the corresponding labor schedule and category suitable for the SOW.

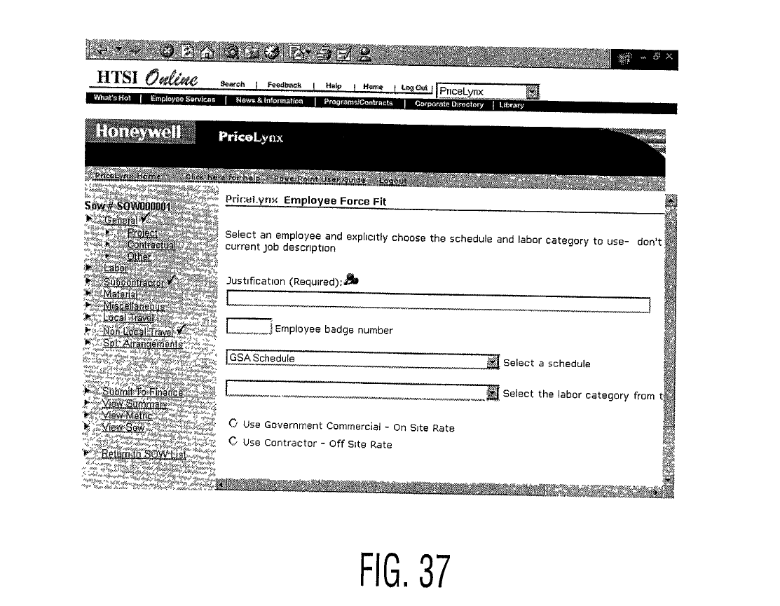

For the Override to Select a Specific Employee option, the quote advisor can select a specific employee by entering an identification or badge number of the employee, and assigning a labor schedule, a labor category, and a site rate as shown in a sample view screen illustrated in FIG. 37. For this option, the quote advisor is required to enter the justification or reason for selecting the specific employee. As described above, the EIT permits the quote advisor to research the qualifications of the specific employee by viewing the specific employee's resume and skills assessment. Examples of proper justifications can include: resume search on the employee indicates that the employee meets the qualification of the labor category; approved by management; approved or requested by the customer; and the like.

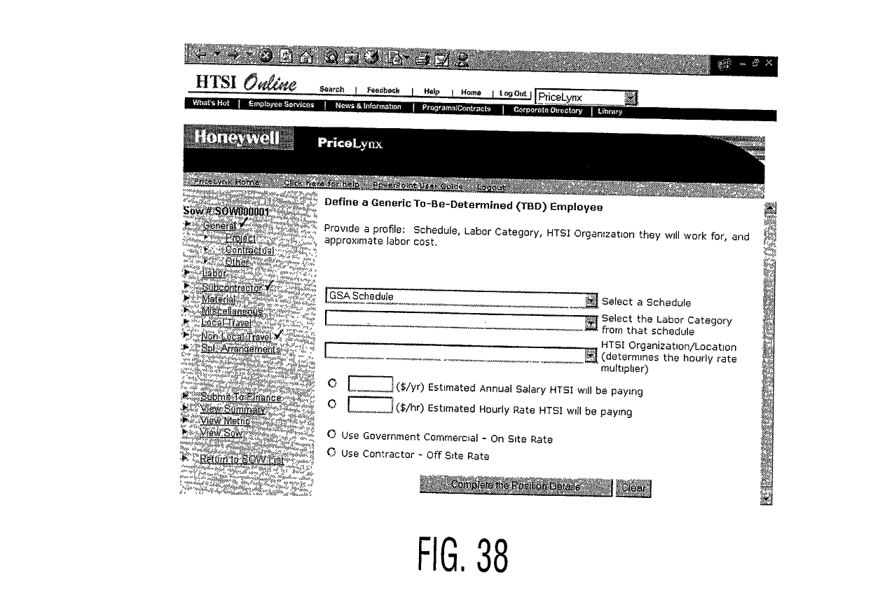

For the Create a Future Hire or To Be Determined Employee option, the quote advisor can define for pricing purposes, a “generic to be determined” employee when a particular employee has not been selected for the SOW as shown in a sample view screen illustrated in FIG. 38. The quote advisor specifies a schedule, a labor category, a site rate, an organization location, and an “unburdened” hourly rate or the annual salary figure.

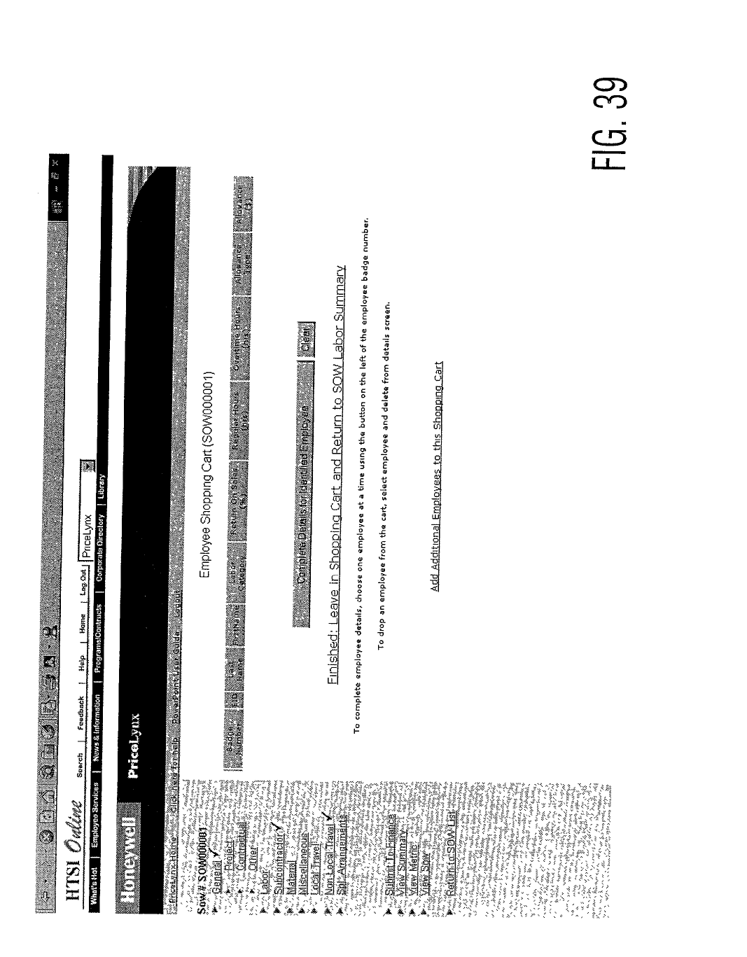

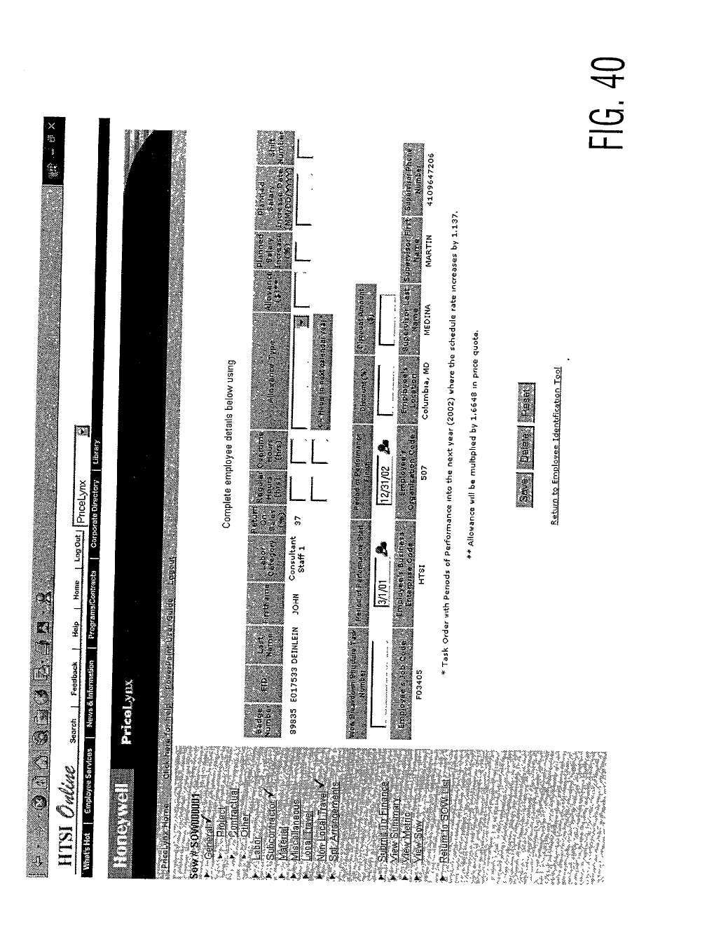

For the Update Employee Shopping Cart option, the quote advisor can view the labor resources selected as shown in a sample view screen illustrated in FIG. 39. The quote advisor has the option to modify the hours or allowances for each of the employees selected for the SOW. The quote advisor can select one or more of the listed employees and click the Complete Details for Identified Employee to make any modifications as shown in a sample view screen illustrated in FIG. 40. The quote advisor can enter in the appropriate data fields the hours in the current year and the subsequent year along with any allowances. The server 12 can also permit the quote advisor to include any discounts by percentage or dollar amounts subject to approval by the review departments. Once the details for the identified employee are entered, the quote advisor must save the data into the SOW for update of the database. The quote advisor is returned to the view screen of FIG. 39. Upon completion and review, the quote advisor must click on the “Finished: Leave in Shopping Cart and Return to SOW Labor Summary” hypertext link to update and record the data in the database to ensure that the evaluation summary report is accurate.

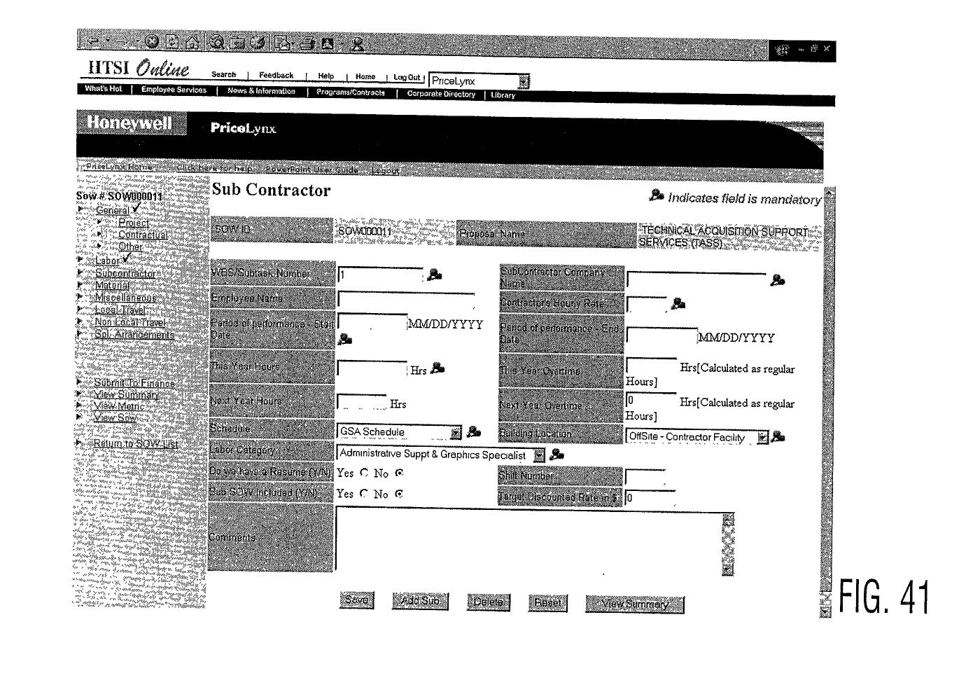

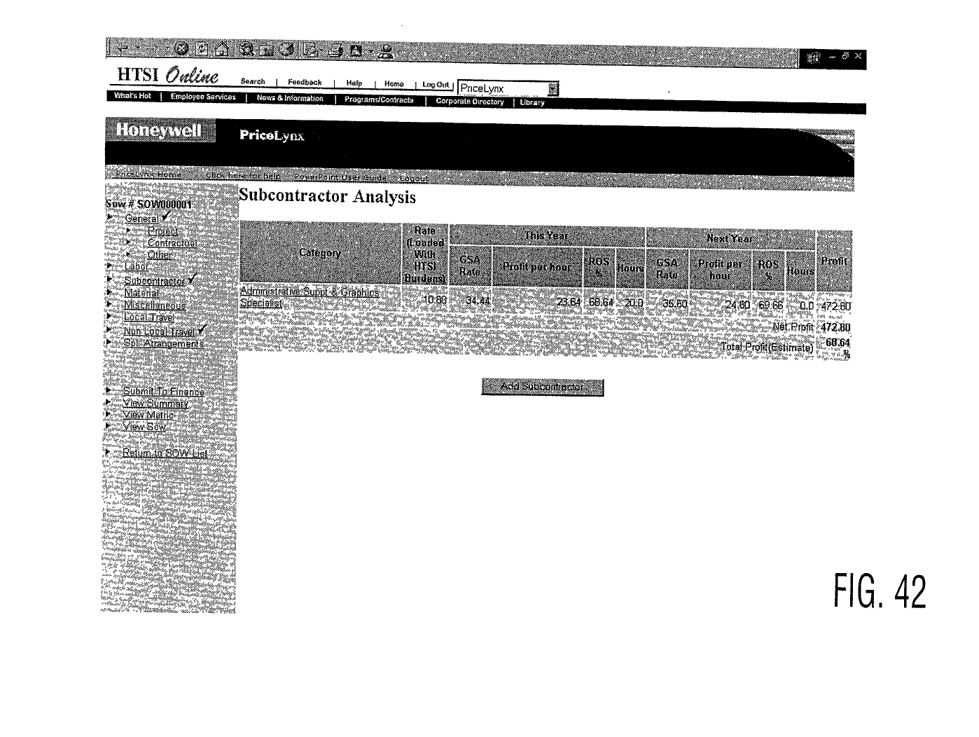

In FIGS. 41 and 42, corresponding sample view screens are illustrated to show an optional selection process for subcontractors. The process is similar to the identification and selection of qualified employees described above. In the view screen of FIG. 41, the quote advisor enters the subcontractor's name, hourly rate, performance period, total hours, schedule, location, and labor category. The quote advisor must save the information entered for incorporation into the SOW. The process can be repeated for additional subcontractors as required. The server 12 can be configured to analyze the profitability of the subcontractor through activation of the View Summary icon button. As an example, the view screen for displaying the subcontractor profitability analysis is shown in FIG. 42.

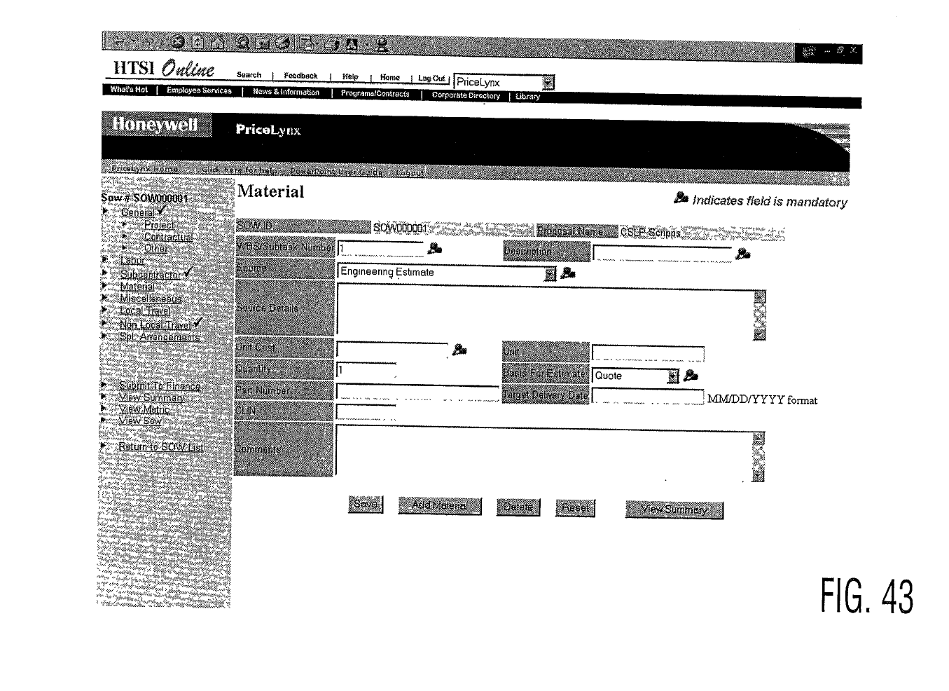

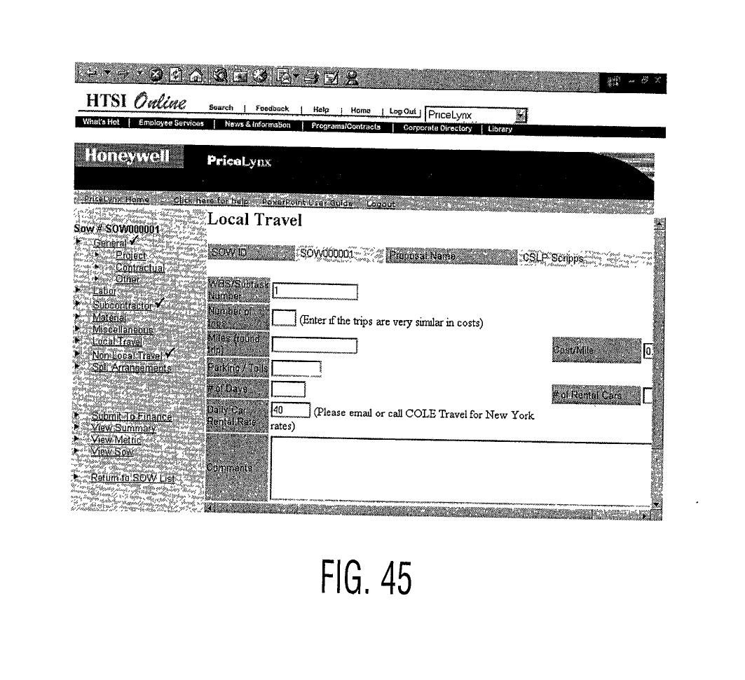

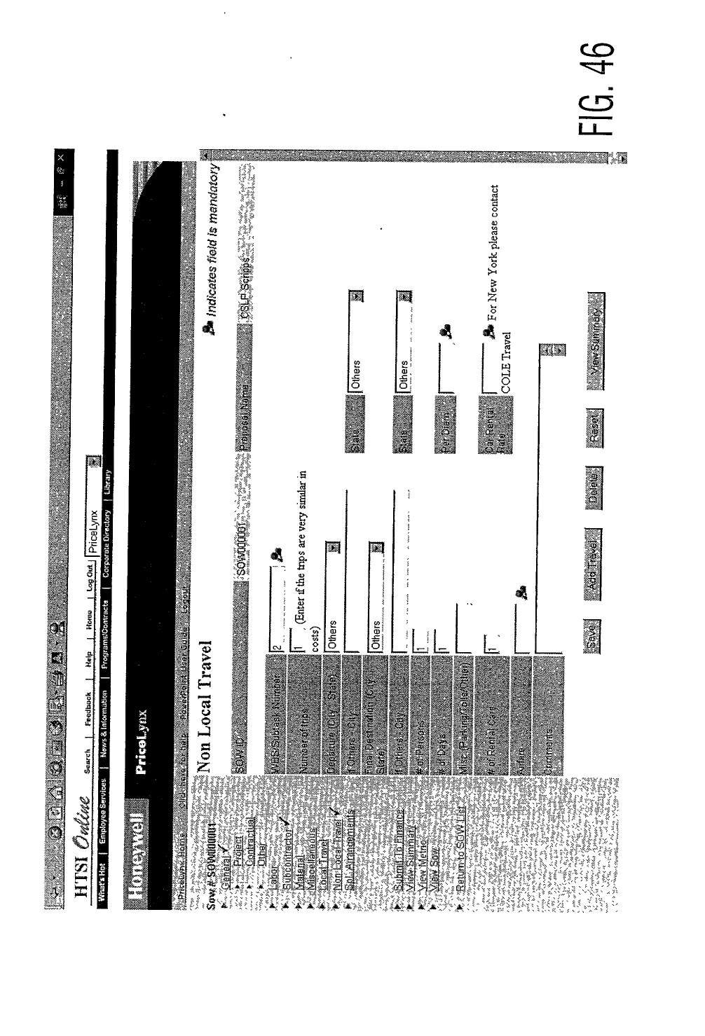

FIGS. 43 to 47 show sample view screens for facilitating identification and selection of other resources and expenditures. In the view screen of FIG. 42, the quote advisor is able to input the required data fields corresponding to materials including description, source, unit cost, and basis of the estimate of each material. The quote advisor saves the information and details inputted into the data fields. In FIG. 43, the quote advisor inputs the required data fields corresponding to miscellaneous direct cost including description, cost, and any comments for each item. Examples of direct costs are telephone expenses, shipping, postage, and the like. The quote advisor saves the information and details inputted. In the sample view screen of FIG. 45, the quote advisor is able to input the required data fields corresponding to costs associated with local travel including the number of trips, round trip miles, any parking or road tolls, rental car costs, and the like. The quote advisor saves the information and details inputted. In the sample view screen of FIG. 46, the quote advisor is able to input the required data fields corresponding to costs associated with nonlocal travel including number of trips, airfare, rental car costs, and the like. In one embodiment of the present invention, the server 12 can be adapted to communicate with a travel agency for remotely obtain travel quotes which is automatically inputted into the SOW. In the sample view screen of FIG. 46, the quote advisor is able to input into the data fields, data corresponding to other costs based on agreements and special arrangements upon receiving proper prior authorization by the company.

Referring back to FIG. 4, once the resources are identified and selected, the SOW can be analyzed to generate a formal quote based on data of the corresponding selected resources as indicated at step 310. It is noted that the server 12 is sufficiently flexible to allow the quote advisor to modify the pricing of the resources in order to more closely match the customer's budget and cost expectations and the agreements made between the quote advisor and the customer during negotiation.

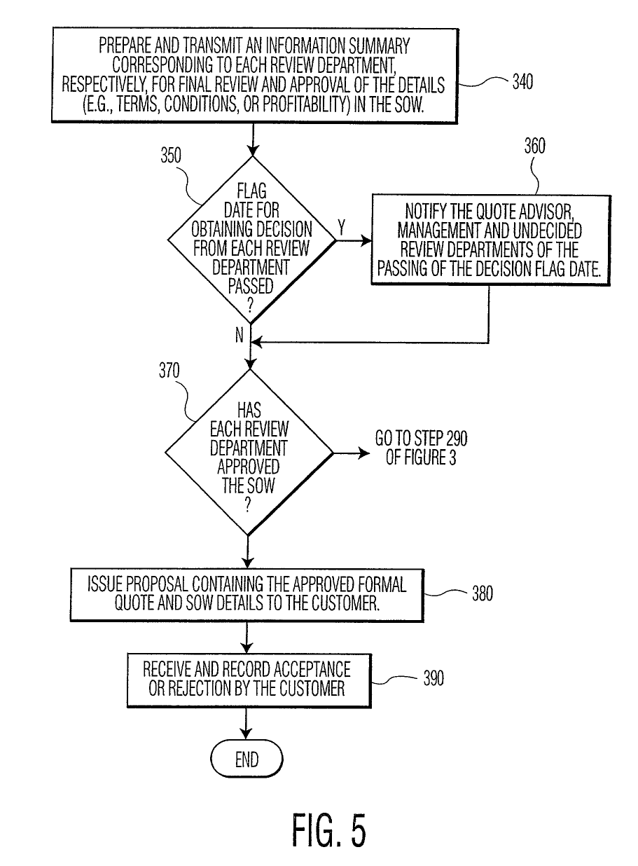

As indicated at decisional step 320, the server 12 queries whether the flag date for generating a formal quote has expired. If the time period has expired, the server 12 notifies the corresponding quote advisor and management personnel via email of the overdue action on the SOW. If the formal quote was generated prior to the flag date, server 12 proceeds to step 340 of FIG. 5.

With reference to FIG. 5, the server 12 proceeds to step 340 where an analysis of the profitability of the formal quote is made and a financial information summary is generated. The financial information summary is transmitted through the server 12 to a finance review department of the company for review and verification of profitability of the project. Typically, when the pricing is generated from the pricing schedule selected from the database 16, the SOW is considered conditionally acceptable by the finance review department. The finance review department can approve the project or negotiate with the quote advisor to obtain a more acceptable pricing offer.

Correspondingly at step 340, a contracts information summary is generated reporting the terms and conditions disclosed in the SOW for the performance of the project or task. The contracts information summary is transmitted through the server 12 to a contracts review department of the company for review and acceptance of the contractual terms and conditions. The contracts review department can approve the project or further negotiate with the customer to obtain more acceptable terms.

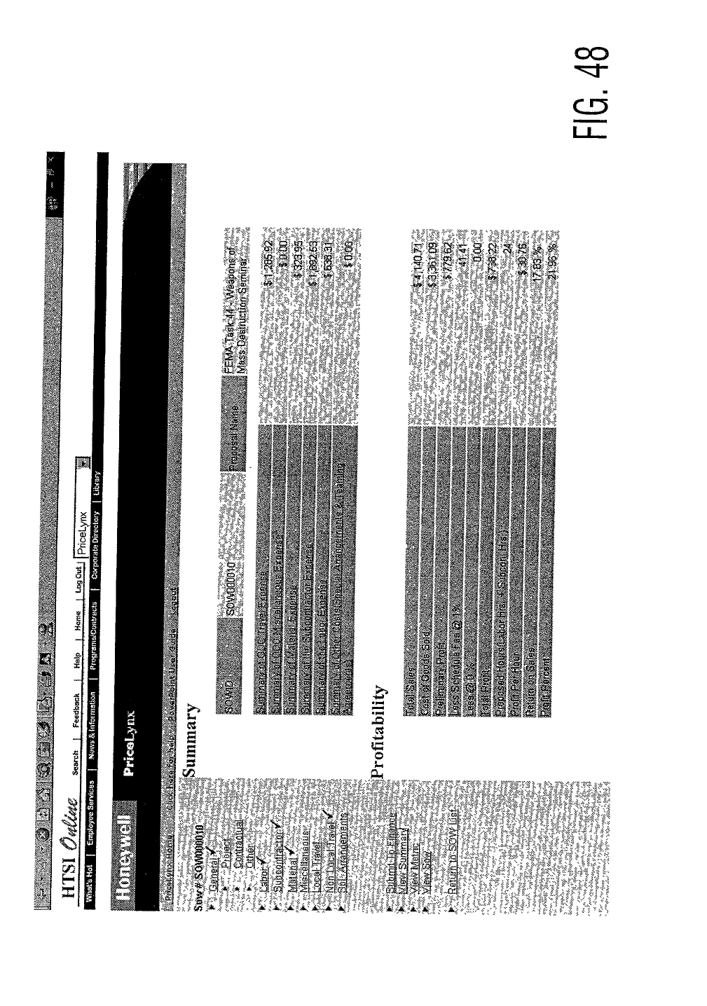

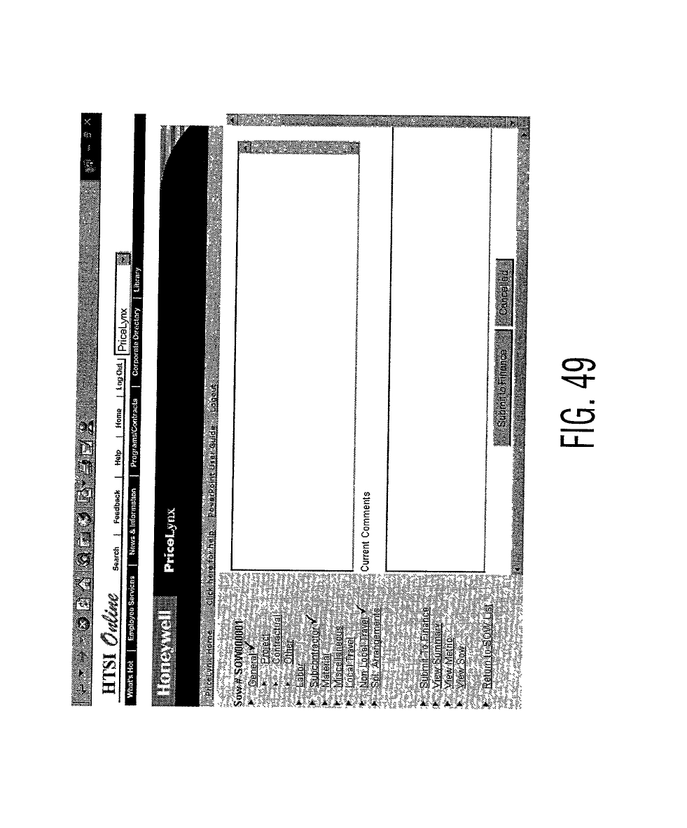

An example of a view screen for facilitating review of a summary of an SOW by the quote advisor at step 340 is shown in FIG. 48. Upon completing the identification and selection of resources and costs, the quote advisor can prepare a summary of the costs and profitability of the SOW as generated in the view screen of FIG. 48. The view screen includes hypertext links for each entry for displaying its corresponding details. The quote advisor and the appropriate review department can access and review different aspects of the SOW. In FIG. 49, an example of a view screen is shown to illustrate the data fields for allowing the quote advisor to input final comments prior to submission to the finance review department. Upon completion, the information and details of the SOW including the summary are submitted to the finance review department for review and approval.

Upon submission of the SOW for review and approval, the server 12 enables the review departments to access and view the corresponding summary where the details of the SOW including the formal quote may be reviewed online. The finance review department determines whether the SOW meets the expectations of the company. Upon approval, an email including hypertext link to the summary is forwarded to the contracts review department for review of the terms of the SOW. If either of the departments rejects the SOW, an email message that documents the reasons for rejection, is sent to the quote advisor. The SOW is also returned to control of the quote advisor for implementing further changes to comply with the review department's findings.

Referring back to FIG. 5, the server 12 proceeds to decisional step 350 to determine whether the time period for obtaining a decision from each review department has expired. If the time period has expired, the server 12 notifies the quote advisor, the management personnel, and the corresponding review departments of the overdue action on the SOW. If the review departments furnish their respective electronic signatures prior to the flag date, the server 12 proceeds to decisional step 370.

At decisional step 370, the server 12 determines whether all of the review departments have approved the SOW and its formal quote. Each of the review departments notifies the quote advisor of the decision, reasons for the decision and a corresponding electronic signature or stamp for certification. If less than all the review departments approved, status of the SOW reverts back to “Under Construction” and the quote advisor is notified of the status change via email and directs the quote advisor to make any remedial modifications to the SOW such as to the financial or contractual terms as indicated in step 290 of FIG. 4.

If the SOW is approved by all the review departments, then a proposal including details of the project, terms and conditions, and the formal quote is submitted to the customer for acceptance or rejection as seen at step 380. Upon acceptance, the server 12 records the acceptance of the SOW by the customer and assigns an order confirmation number to the SOW. The SOW is converted into an order where the quote advisor is notified and directed to begin the project or task.

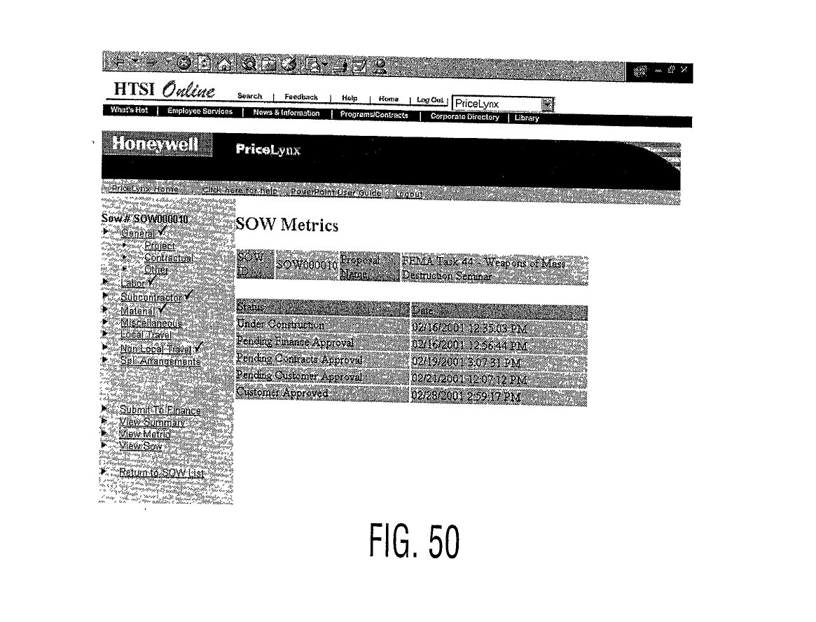

An example of a view screen for detailing the metrics for an SOW is shown in FIG. 50. The server 12 is configured to record the status history of the SOW and the corresponding dates. For each change of status, a corresponding email notification is sent to the customer, management personnel, quote advisor and the review departments to keep all parties advised of the progress of the SOW throughout the quote process. The metrics are prepared to show the time expended for each event in the quote process. This information is recorded and updated in the customer database for subsequent retrieval and display to the customer.

It is noted that the depicted view screens, templates, forms, and reports of the invention can include fewer or greater number of data fields with the addition or deletion of choices or with the consolidation and expansion of choices as desired. Additionally, it is further noted that certain of the data fields can substitute menu selections or a lookup table for text entry fields or vice versa, according to the design criteria of the application. Save and reset buttons can be used in combination with one or more templates, forms, and reports. A data field can be provided to allow files to be entered into a template, form, or report such as a system plan, or schematic diagram to facilitate understanding of a project or task. A feedback means can be provided to allow users to convey assessment information of the server 12 to the controller of the server 12 so that the server 12 can be continuously improved and repaired.

Although various embodiments of the invention have been shown and described, they are not meant to be limiting. Those of skill in the art may recognize various modifications to these embodiments, which modifications are meant to be covered by the spirit and scope of the appended claims. For example, although a computer hardware system is shown and described herein, numerous other computer hardware systems can be programmed to practice the method of the present invention.

What is claimed is:

1. A method implemented via a computerized system for coordinating business information flow to permit a provider of goods or services to prepare a project proposal including a price quote for a project requested by a customer, said system including a central server programmed to execute said method, said method comprising the steps of:
establishing a communications channel between the central server and at least one client computer;
creating a statement of work comprising project data corresponding to project details, terms, requirements, and comments using a project information template;
transmitting the statement of work over the communications channel to the central server from one of the at least one client computer to initiate preparation of the project proposal;
searching a resource database storing resource data relating to available resources using a search template to identify and select the available resources suitable for completing the project defined by the statement of work;
processing data relating to selected resources and project data of the statement of work to generate the price quote and prepare the project proposal; and
preparing an evaluation summary report of the project proposal, detailing the project data and selected resource data of selected available resources for review and approval by the provider of goods or services.

2. The computerized system of claim 1, further comprising the step of transmitting the evaluation summary report to ones of the at least one client computer accessed by appropriate review departments of the provider for review and approval of the project proposal.

3. The method of claim 2, wherein the evaluation summary report includes financial evaluation of the project proposal, and one of the appropriate review departments is a finance review department.

4. The method of claim 2, wherein the evaluation summary report includes contractual compliance evaluation, and one of the appropriate review departments is a contracts review department.

5. The method of claim 1, further comprising the step of notifying the customer of the project proposal including the price quote upon approval by the provider.

6. The method of claim 5, wherein the notifying step further comprises the step of transmitting the project proposal over the communications channel to one of the at least one client computer accessed by the customer for viewing.

7. The method of claim 1, further comprising the step of storing in a customer database, status information corresponding to current status and history of the statement of work in the business information flow for viewing by the customer.

8. The method of claim 1, further comprising the step of storing in a personnel database, information relating to internal record of the statement of work for access by personnel of the provider.

9. The method of claim 1, further comprising the steps of:
assigning the transmitted statement of work to a quote advisor for facilitating the preparation of the project proposal from the statement of work; and
notifying the assigned quote advisor and the customer of the assignment and contact information of the quote advisor and the customer.

10. The method of claim 1, further comprising the steps of posting flag dates for at least one event during the preparation of the project proposal; and
notifying the provider of the passing of flag dates for each corresponding event.

11. The method of claim 1, further comprising the steps of:
preparing a tentative statement of work including project data inputted by the customer through use of a tentative statement of work template;
transmitting the tentative statement of work over the communications channel to the central server from one of the at least one client computer accessed by the customer to generate a tentative order of magnitude;
notifying the customer of the tentative order of magnitude via the communication channel for acceptance; and
converting the tentative statement of work upon acceptance of the tentative order of magnitude.

12. The method of claim 7, further comprising the steps of:
qualifying a user of one of the at least one client computer for access of the central server through input of a userid code and a corresponding password code; and
identifying the user as a company user or a customer user.

13. The method of claim 12, further comprising the step of limiting access by the customer user to the central server for searching and viewing status of each statement of work created by the customer user on the customer database.

14. The method of claim 6, further comprising the step of receiving acceptance or rejection of the project proposal from the customer over the communications channel from one of the client computers accessed by the customer.
